(19) United States
(12) Patent Application Publication
(10) Pub. No.: US 2007/0173291 A1
(43) Pub. Date: Jul. 26, 2007

(54) Information communication terminal, information processing method and information processing program

(76) Inventor: Shiro Morotomi, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/641,887

(22) Filed: Dec. 20, 2006

(30) Foreign Application Priority Data
Dec. 28, 2005 (JP) 2005-377372

(51) Int. Cl. H04B 1/38; H04M 1/00

(52) U.S. Cl. 455/566

(57) ABSTRACT

Disclosed herein is an information communication terminal including: a light emitting section configured to emit light in accordance with an operation carried out by said information communication terminal; a state detection section configured to detect an operating state of said information communication terminal; and a control section configured to execute control of changing the state of emission of said light emitted by said light emitting section on the basis of said operating state detected by said state detection section.

### CROSS REFERENCES TO RELATED APPLICATIONS

The present invention contains subject matter related to Japanese Patent Application JP 2005-377372, filed in the Japanese Patent Office on Dec. 28, 2005, the entire contents of which being incorporated herein by reference.

### BACKGROUND OF THE INVENTION

1. Field of the Invention

The present invention relates to an information communication terminal, an information processing method and an information processing program. More particularly, the present invention relates to an information communication terminal capable of visually displaying the operating state of the information communication terminal as well as relates to an information processing method adopted by the information communication terminal and an information processing program implementing the information processing method.

2. Description of the Related Art

Nowadays, portable radio communication terminals such as a hand phone and a PHS are used widely. Normally, these portable radio communication terminals each display a wave reception sensitivity and information indicating whether or not a communication line can be used.

Foldable hand phones each have indicators on outer faces thereof as indicators each used for showing an operating state in a folded state of the phone main body. For example, some foldable hand phones each have a display lamp indicating whether or not the phone can be used, that is, whether the phone is inside or outside a communication range, while other foldable phones each have two light emitting devices used for indicating the strength of a reception field and the amount of residual charge left in its battery respectively.

Documents such as Patent Document 1 disclose a technology for emitting light in such a way that the user is capable of recognizing both the sensitivity of radio reception and determining whether or not a communication line is being used. As Patent Document 1, this specification uses Japanese Patent Laid-open No. Hei 11-340900.

### SUMMARY OF THE INVENTION

In accordance with the technology disclosed in Patent Document 1 cited above, however, a diode merely turns on or off, depending upon whether data is being communicated or not and, thus, the diode in the on state does not notify the user that data is being transmitted or received.

Addressing the problem described above, inventors of the present invention have devised an information communication terminal capable of visually displaying the operating state of the information communication terminal as well as devised an information processing method adopted by the information communication terminal and an information processing program implementing the information processing method.

In accordance with a first embodiment of the present invention, there is provided an information communication terminal. The information communication terminal includes: a light emitting section configured to emit light in accordance with an operation carried out by the information communication terminal; a state detection section configured to detect an operating state of the information communication terminal; and a control section configured to execute control of changing the state of emission of the light emitted by the light emitting section on the basis of the operating state detected by the state detection section.

It is possible to provide the information communication terminal with a configuration in which the control section changes the luminance of light emitted by the light emitting section in accordance with whether the information communication terminal is transmitting or receiving data.

In addition, it is also possible to provide the information communication terminal with a configuration in which the control section gradually increases the luminance of light emitted by the light emitting section in order to gradually raise the level of brightness while the information communication terminal is transmitting data.

On top of that, it is also possible to provide the information communication terminal with a configuration in which the control section gradually decreases the luminance of light emitted by the light emitting section in order to gradually raise the level of darkness while the information communication terminal is receiving data.

Furthermore, it is also possible to provide the information communication terminal with a configuration in which the light emitting section emits light through a light guide tube.

In accordance with a second embodiment of the present invention, there is provided an information processing method or a program implementing the information processing method. The information processing method or the program implementing the information processing method includes the steps of: driving a light emitting section employed in the information communication terminal to emit light indicating an operation carried out by the information communication terminal; detecting an operating state of the information communication terminal; and executing control to change the level of brightness/darkness of light emitted by the light emitting section on the basis of the operating state detected at the operation-state detecting step.

According to either of the information processing method and the information processing program, which are provided in accordance with the second embodiment of the present invention, a light emitting section employed in the information communication terminal is driven to emit light indicating an operation carried out by the information communication terminal; an operating state of an information communication terminal is detected; and control is executed to change the level of brightness/darkness of light emitted by the light emitting section on the basis of the operating state detected at the operation-state detecting step.

In accordance with the first embodiment of the present invention, there is provided an information communication terminal capable of visually displaying the operating state of the information communication terminal.

### BRIEF DESCRIPTION OF THE DRAWINGS

FIG. 1 is an explanatory diagram showing an information communication system including information communication terminals each provided by the present invention;

FIG. 2 is a diagram showing the front view of the external appearance of the information communication terminal;

FIG. 3 is a diagram showing the rear view (opposite side to the face on which the display unit is visible) of the external appearance of the information communication terminal;

FIG. 4 is a diagram showing the top view of the external appearance of the information communication terminal where the top is defined as the side having a WLAN on/off switch;

FIG. 5 is a diagram showing the right-side view of the external appearance of the information communication terminal where the right side is defined as the side located in the right when seen from a position at which a display unit of the information communication terminal is visible or, in other words, the right side is defined as the side having a communication-state notification light emitting unit 34;

FIG. 6 is a diagram showing the left-side view of the external appearance of the information communication terminal where the left side is defined as the side located in the left when seen from a position at which the display unit of the information communication terminal is visible or, in other words, the right side is defined as the side having the WLAN on/off switch and a power-supply switch;

FIG. 7 is a diagram showing the bottom view of the external appearance of the information communication terminal where the bottom is defined as the side having the power-supply switch and a music key;

FIG. 8 is a diagram showing the front view of the external appearance of the information communication terminal with its cover slid upward;

FIG. 9 is a diagram showing an external appearance of the inside of the keyboard employed in the information communication terminal;

FIG. 10 is an explanatory diagram showing a continuous display panel;

FIG. 11 explains pieces of information shown on the continuous display panel;

FIG. 12 is a block diagram showing the internal configuration of the information communication terminal;

FIG. 13 is a software-stack diagram showing the configuration of software executed by an application processor;

FIG. 14 is a software-stack diagram showing the configuration of software executed by an audio processor;

FIG. 15 is a diagram showing a typical display of a home screen;

FIG. 16 is a diagram showing a model serving as a circuit including a light emitting device employed in a communication-state notification light emitting unit;

FIG. 17 is a block diagram showing a typical functional configuration of the communication-state notification light emitting unit;

FIG. 18 is a diagram showing typical light modulation in a process to transmit data;

FIG. 19 is a diagram showing typical light modulation in a process to receive data;

FIG. 20 is a diagram showing other typical light modulation in a process to transmit data;

FIG. 21 is a diagram showing other typical light modulation in a process to receive data;

FIG. 22 is a diagram showing typical light modulation at a VoIP arrival;

FIG. 23 is a diagram showing typical light modulation at a VoIP outgoing;

FIG. 24 is a diagram showing other typical light modulation at a VoIP arrival;

FIG. 25 is a diagram showing other typical light modulation at a VoIP outgoing;

FIG. 26 shows a flowchart representing processing to carry out a file transfer function to receive a data file;

FIG. 27 shows a flowchart representing processing carried out at a step S2 of the flowchart shown in FIG. 26; and

FIG. 28 shows a flowchart representing processing to carry out a file transfer function to transmit a data file.

### DETAILED DESCRIPTION OF THE PREFERRED EMBODIMENT

Before preferred embodiments of the present invention are explained, relations between disclosed inventions and the embodiments are explained in the following comparative description. This description is intended to ensure that the embodiments according to the present invention conform to the specification and drawings therein. It is to be noted that, even if there is an embodiment described in this specification but not included in the following comparative description as an embodiment corresponding to an invention, such an embodiment is not to be interpreted as an embodiment not corresponding to an invention. Conversely speaking, an embodiment included in the following comparative description as an embodiment corresponding to a specific invention is not to be interpreted as an embodiment not corresponding to an invention other than the specific invention.

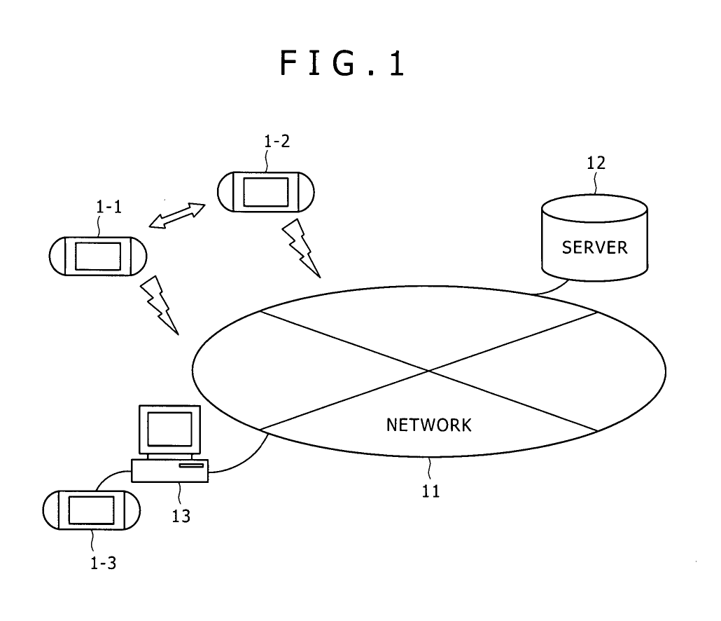

Information communication terminals 1-1 to 1-3 shown in FIG. 1 are examples of an information communication terminal 1 according to the present invention. Typically, the information communication terminal includes a light emitting section (such as a light emitting unit 524 shown in FIG. 17) configured to emit light in accordance with an operation carried out by the information communication terminal; and a state detection section (such as a state detection unit 521 shown in FIG. 17) configured to detect an operating state of the information communication terminal. The terminal further includes a control section (such as a control unit 522 shown in FIG. 17) configured to execute control of changing the state of emission of the light emitted by the light emitting section on the basis of the operating state detected by the state detection section.

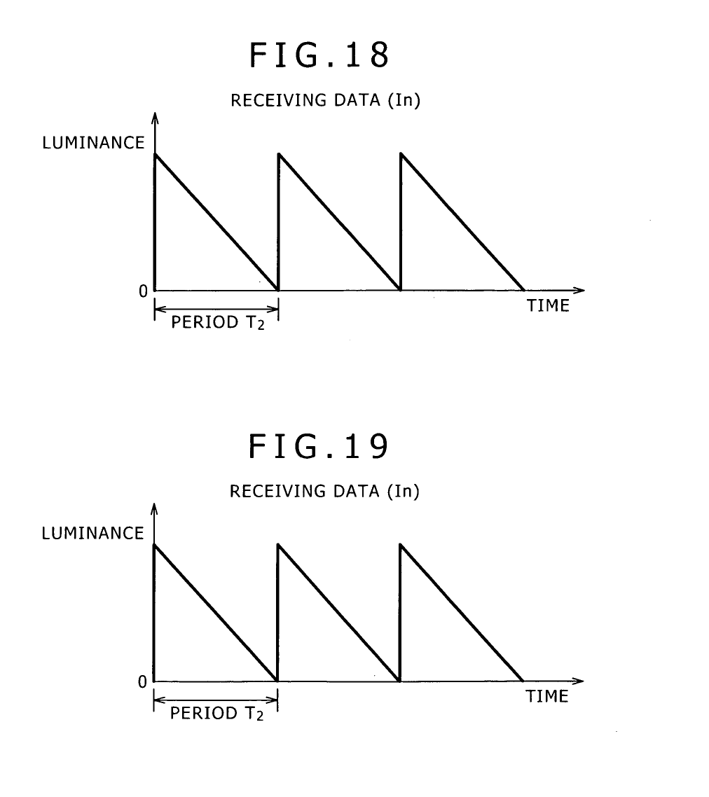

The control section employed in the information communication terminal is capable of controlling a light modulation section (such as a light modulation unit 523 shown in FIG. 17) to change the luminance of a light beam emitted by the light emitting section in accordance with whether data is being received or transmitted as shown in light modulations of FIGS. 18 to 25.

To be more specific, for example, the control section employed in the information communication terminal gradually increases the luminance of the light emitted by the light emitting section in order to gradually raise the level of brightness of the emitted light periodically with a period T1 during a process to transmit data as shown in FIG. 18.

To be more specific, for example, the control section employed in the information communication terminal gradually decreases the luminance of the light emitted by the light emitting section in order to gradually lower the level of brightness of the emitted light periodically with a period T2 during a process to receive data as shown in FIG. 19.

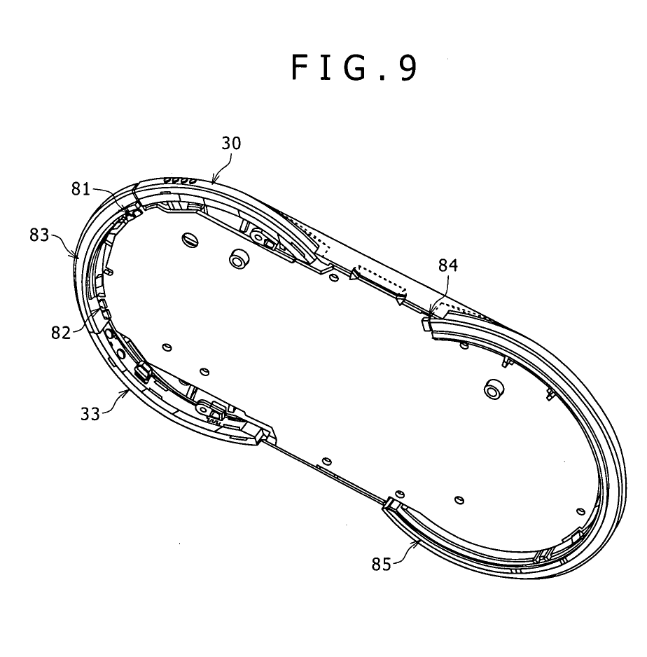

The light emitting section is capable of emitting a light beam by typically driving a light emitting device (such as a light emitting device 84 shown in FIG. 9) through a light guide tube (such as a light guide tube 85 shown in FIG. 9).

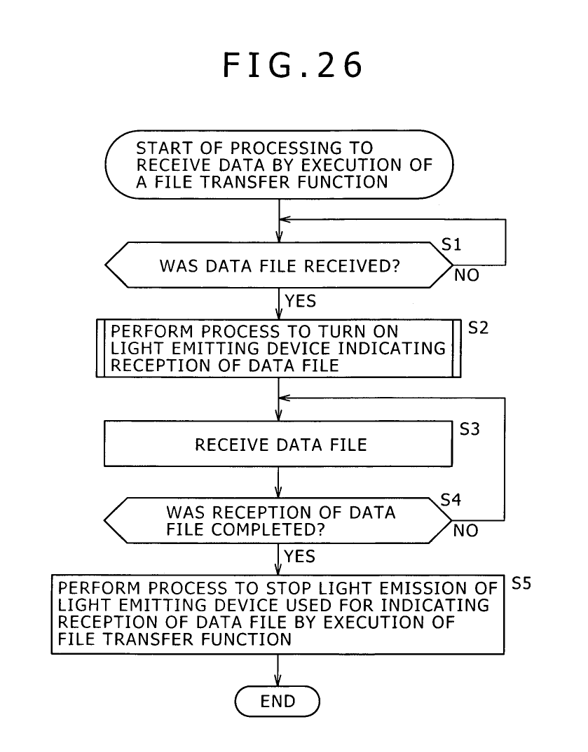

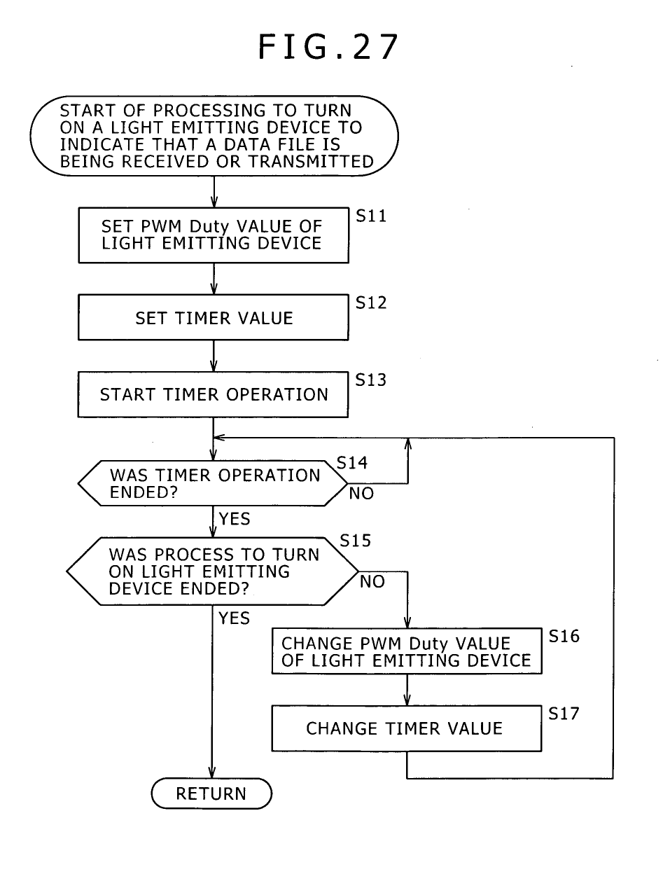

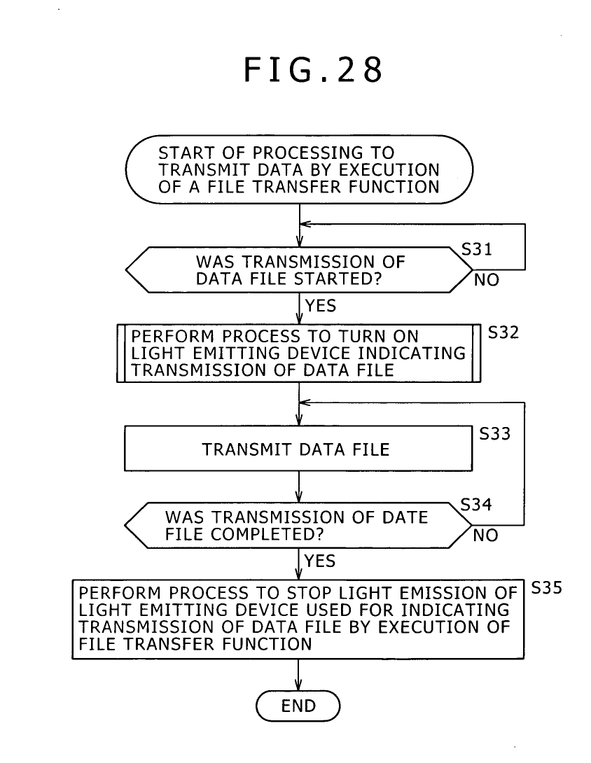

Either one of an information processing method and an information processing program, which are provided in accordance with an embodiment of the present invention, includes the steps of: emitting a light beam in accordance with an operation carried out by the information communication terminal (such as a process carried out at a step S1 a flowchart shown in FIG. 26 or a step S31 of a flowchart shown in FIG. 28); and executing control to change the level of brightness/level of darkness of the emitted light in accordance with the detected operating state of the information communication terminal (such as processes carried out at steps S11 to S17 of a flowchart shown in FIG. 27).

The embodiments of the present invention are explained by referring to diagrams as follows.

By referring to FIG. 1, the following description explains an information communication system including information communication terminals 1-1 to 1-3 each provided by the present invention. It is to be noted that the information communication terminals 1-1 to 1-3 shown in FIG. 1 have the same functions.

Typically, the information communication terminals 1-1 to 1-3 each execute a variety of programs in order to carry out a variety of functions such as a function to communicate information through radio or wired communication, a function to record various kinds of information, a function to reproduce audio and video data, a function to display various kinds of information such as recorded information, reproduced video information an GUI (Graphic User Interface) information serving as an aid helping the user enter an operation input via a variety of input devices and a function to receive an operation input entered by the user. In the following description, the information communication terminals 1-1 to 1-3 are each referred to simply as an information communication terminal 1, which is a generic name representing the information communication terminals 1-1 to 1-3, in case there is no need to distinguish the information communication terminals 1-1 to 1-3 from each other.

To put it concretely, the information communication terminal 1 has a WLAN (Wireless Local Area Network meaning a radio LAN) function conforming to typically a 802.11b standard as a function allowing the information communication terminal 1 to be connected to other apparatus and making the information communication terminal 1 capable of exchanging information with the other apparatus. The information communication terminal 1 is capable of selecting either an infrastructure mode or an ad-hoc mode. The WLAN infrastructure mode is a mode in which the information communication terminal 1 carries out a communication with another information communication terminal through an access point in the WLAN. On the other hand, the WLAN ad-hoc mode is a mode in which the information communication terminal 1 carries out a communication with another information communication terminal without using an access point in the WLAN. The information communication terminal 1 can also be connected to another apparatus by using a cable conforming to typically a USB (Universal Serial Bus) 2.0 standard so that the information communication terminal 1 is capable of exchanging information with the other apparatus. It is to be noted that the USB connection of the information communication terminal 1 may be implemented in accordance with either of an MSC (Mass Storage Class) mode and an MTP (Media Transfer Protocol) mode, either of which can be selected as a USB mode.

That is to say, if the information communication terminal 1 is an apparatus subscribing a predetermined service or an apparatus having a predetermined application program installed therein in order to implement predetermined setting, the information communication terminal 1 is capable of exchanging information with or without a predetermined access point with not only another information communication terminal, but also any other apparatus through a radio or wire communication.

Typically, the information communication terminal 1 includes a flash memory having a typical storage capacity of about 1 GB besides an ordinary volatile memory. In addition, if necessary, the information communication terminal 1 may be typically further provided with a large-capacity storage unit such as a hard disk. On top of that, the information communication terminal 1 has an LCD (Liquid Crystal Display) unit serving as a display device and also has a keyboard used as an input device. If necessary, the information communication terminal 1 may also be provided with other connected input devices such as a mouse and/or a joystick. The information communication terminal 1 may also be provided with a touch panel in addition to the LCD unit if required.

In addition, the information communication terminal 1 is capable of recording audio data supplied thereto and reproducing recorded audio data in accordance with an audio coding method such as an ATRAC3 (Advanced Transform Acoustic Coding 3) method, an MP3 (MPEG Audio Layer-3) method or a WMA (Windows (a registered trademark) Media Audio) method. Furthermore, the information communication terminal 1 also has the so-called photo viewer function for storing video data and reproducing as well as displaying the recorded video data. Moreover, the information communication terminal 1 is capable of avoiding operations such as distribution and exchanging of illegal data without a consent given by its copyright holder in accordance with various kinds of DRM (Digital Rights Management) such as OpenMG management or WMT10 (Janus) management.

On top of that, the information communication terminal 1 may have a variety of application programs installed therein as programs to be executed to carry out various kinds of processing. The application programs include an IP telephone program, an instant messenger, an email program, a web browser and a text editor.

Furthermore, the information communication terminal 1 has such a size that the information communication terminal 1 can be grasped by a hand of the user, providing desirable convenience such as portability to the user.

In addition, the information communication terminal 1 can be connected to a network 11 such as the Internet directly by a radio communication so that the information communication terminal 1 is capable of exchanging information with a variety of servers 12, a variety of personal computers 13 and other information communication terminals 1 through the network 11. The other information communication terminals 1 are any of the information communication terminals 1-1 to 1-3 shown in the figure.

Moreover, the information communication terminal 1 is also capable of exchanging information directly with other information communication terminals 1 by a radio communication. The other information communication terminals 1 are any of the information communication terminals 1-1 to 1-3 shown in the figure.

On top of that, the information communication terminal 1 can be connected to the personal computer so that the information communication terminal 1 is capable of exchanging information with the personal computer 13 as well as a variety of servers and other information communication terminals through the network 11 (such as the Internet) connected to the personal computer 13. In the example shown in the figure, the information communication terminal 1-3 is connected to the personal computer 13.

In addition, it is needless to say that the network 11 employed in the information communication system can be connected to more information communication terminals 1, more servers 12 and more personal computers 13.

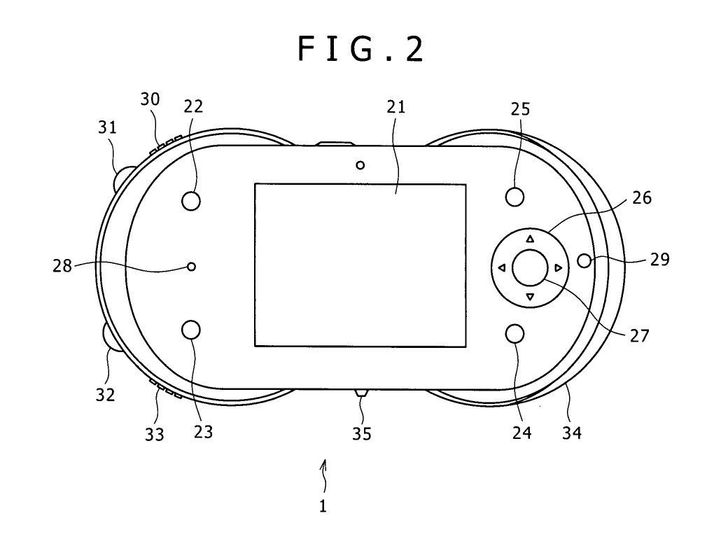

Next, the external appearance of the information communication terminal 1 is explained by referring to FIGS. 2 to 9. FIG. 2 is a diagram showing the front view of the external appearance of the information communication terminal 1.

As shown in the figure, the front face of the information communication terminal 1 has a display unit 21, a WLAN-mode switching button 22, a home button 23, a back button 24, an option button 25, 4-direction keys 26, an enter button 27, a speaker 28 and a mike 29. The left-side face of the information communication terminal 1 includes a WLAN on/off switch 30, a WLAN-state notification light emitting unit 31, a power-supply-state notification light emitting unit 32 and a power-supply switch 33. The left-side face is a face located on the left side when seen from a position facing the display unit 21. The right-side face of the information communication terminal 1 has a communication-state notification light emitting unit 34. The right-side face is a face located on the right side when seen from the position facing the display unit 21. The bottom of the information communication terminal 1 has a music key 35. The bottom is a face located on the lower side when seen from the position facing the display unit 21.

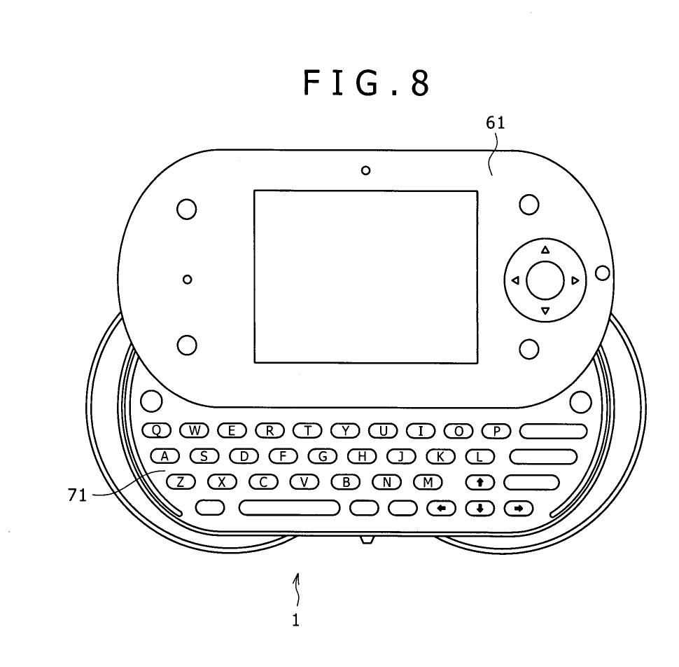

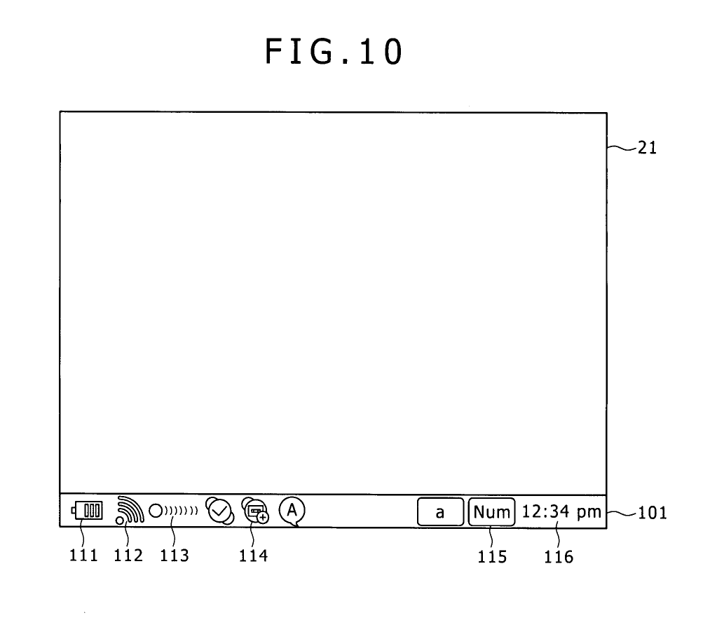

The display unit 21 is typically a flat display unit such as an LCD unit capable of displaying various kinds of information. The information displayed on the display unit 21 includes information on the state of the information communication terminal 1. Displays of the information on the state of the information communication terminal 1 are explained by referring to FIGS. 8 and 10. Other information displayed on the display unit 21 in various kinds of processing carried out by the information communication terminal 1 will also be properly described later.

The WLAN-mode switching button 22 is a button to be operated by the user to enter an operation input for switching the radio LAN on and off.

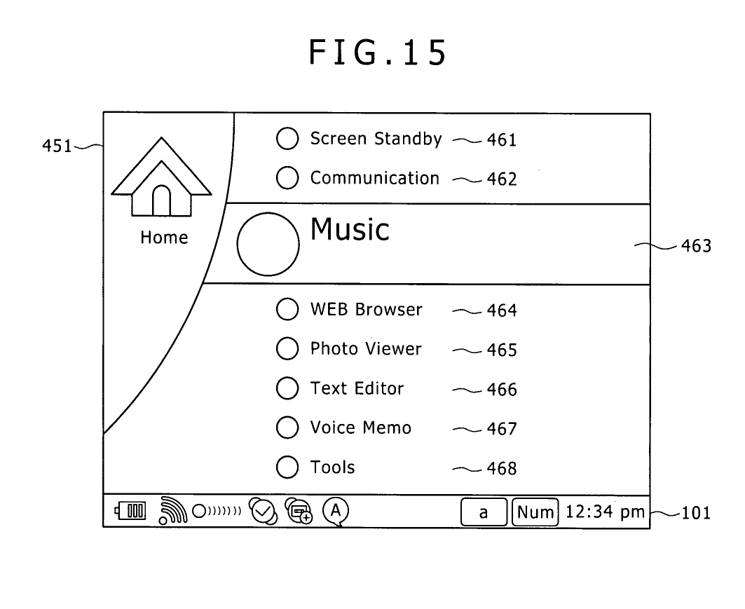

The home button 23 is a button to be operated by the user to enter an operation input for displaying a home menu on the display unit 21 without regard to the type of information currently displayed on the display unit 21. The home menu will be described later by referring to FIG. 15.

The back button 24 is a button to be operated by the user to enter an operation input for restoring the display screen displayed immediately before the current display screen.

The option button 25 is a button to be operated by the user to enter an operation input for showing a display screen used for displaying a variety of optional tools.

The 4-direction keys 26 are each a key to be operated by the user to enter an operation input for moving typically a cursor over a screen of information displayed on the display unit 21 in one of four directions, changing typically a selected button or a selected icon or carrying out another operation.

The enter button 27 is a button to be operated by the user to enter an operation input for making a final decision to determine a selected menu, a selected button, a selected icon or another selected item.

The speaker 28 is a speaker for outputting voices of a phone conversation such as in an IP telephone call and sounds reproduced by a predetermined application. The sounds reproduced by a predetermined application are audio data recorded in advance in the information communication terminal 1.

The mike 29 is an input component for inputting voices of a phone conversation in an IP telephone call and sounds acquired by a predetermined application.

The WLAN on/off switch 30 is a switch to be operated by the user to switch a radio communication function of the information communication terminal 1 from an enabled state to a disabled state and vice versa.

The WLAN-state notification light emitting unit 31 is typically a light emitting device 81 such as a LED (light emitting diode) and a light guide tube 83 shown in FIG. 9. The WLAN-state notification light emitting unit 31 is a component for notifying the user of an enabled state or a disabled state of the radio communication function included in the information communication terminal 1. For example, if the radio communication function included in the information communication terminal 1 is in the enabled state, the WLAN-state notification light emitting unit 31 is turned on to emit light. If the radio communication function included in the information communication terminal 1 is in the disabled state, on the other hand, the WLAN-state notification light emitting unit 31 is turned off to cease transmission of light. In order to turn on the WLAN-state notification light emitting unit 31, the WLAN-state notification light emitting unit 31 drives the light emitting device 81 to emit light through the light guide tube 83.

The power-supply-state notification light emitting unit 32 is typically a light emitting device 82 and a light guide tube 83 having an LED (light emitting diode). The power-supply-state notification light emitting unit 32 is a component for notifying the user of information such as information on whether or not the power supply of the information communication terminal 1 has been turned on and whether the power supply is being electrically charged or the process to electrically charge the power supply has been completed. For example, the power-supply-state notification light emitting unit 32 is put in an on state when the power supply is turned on. When the power supply is turned off, on the other hand, the power-supply-state notification light emitting unit 32 is also put in an off state as well. In addition, when the power supply is being electrically charged, the power-supply-state notification light emitting unit 32 is put in an on state showing a color different from a color, which is shown when the power supply is turned on. In order to turn on the power-supply-state notification light emitting unit 32, the power-supply-state notification light emitting unit 32 drives the light emitting device 82 to emit light through the light guide tube 83.

The power-supply switch 33 is a switch for turning the power supply of the information communication terminal 1 on or off.

The communication-state notification light emitting unit 34 is typically a light emitting device 84 having an LED (light emitting diode) and a light guide tube 85 shown in FIG. 9. The communication-state notification light emitting unit 34 is a component for notifying the user of the communication state of the information communication terminal 1. For example, in a WLAN infrastructure mode, the communication-state notification light emitting unit 34 is put in an on state showing a color different from a color, which is shown in a WLAN ad-hoc mode. When an IP telephone call arrives, the communication-state notification light emitting unit 34 is put in either of an on state and a blinking state, which show another color. That is to say, the communication-state notification light emitting unit 34 is put in an off state or either of the on and blinking states showing different colors depending on the radio communication state of the information communication terminal 1. In order to turn on the communication-state notification light emitting unit 34 or put the communication-state notification light emitting unit 34 in a blinking state, the communication-state notification light emitting unit 34 drives the light emitting device 84 to emit light through the light guide tube 85. Detail of the communication-state notification light emitting unit 34 will be described in the following description.

The WLAN infrastructure mode is a mode adopting a method of communication through a radio LAN access point. On the other hand, the WLAN ad-hoc mode adopting a method to directly exchange data among apparatus without making use of a radio LAN access point.

The music key 35 is a key used for entering an input making a request for an operation such as an operation to start a reproduction process, an operation to end a reproduction operation, a fast-forward operation, a rewind operation, a temporary stop, a reversed-direction AMS (Auto Music Scan) for the beginning of a piece of music or another operation.

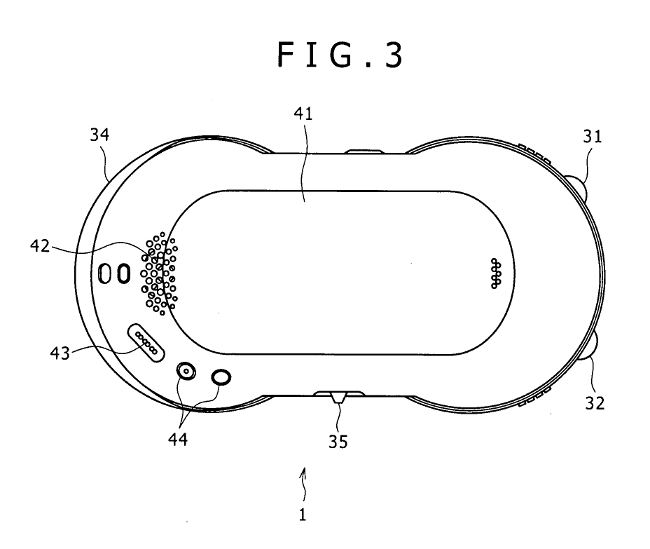

FIG. 3 is a diagram showing the rear view of the external appearance of the information communication terminal 1. The rear face is the face on the opposite side of the display unit 21.

As shown in the figure, the rear face of the information communication terminal 1 includes a battery cover 41 in addition to a ringer speaker 42, a hold switch 43 and a volume button 44, which are provided on a side in close proximity to the communication-state notification light emitting unit 34.

The battery cover 41 covers a battery mounting portion and a battery for supplying power to a variety of components employed in the information communication terminal 1.

The ringer speaker 42 is a speaker used mainly for outputting musical data stored on and reproduced from the information communication terminal 1 or outputting musical data streamed from another information communication terminal 1. The ringer speaker 42 is also a speaker for outputting, for example, a calling sound in the event of an arriving IP phone call.

The hold switch 43 is a switch to be operated by the user to invalidate inputs entered via all buttons and all switches in order to prevent an operation unintended by the user from being carried out due to an inadvertent operation performed on any of the buttons and switches typically when the information communication terminal 1 is kept in a pocket or a bag.

The volume button 44 is a button to be operated by the user to adjust the volume of a sound output by the ringer speaker 42.

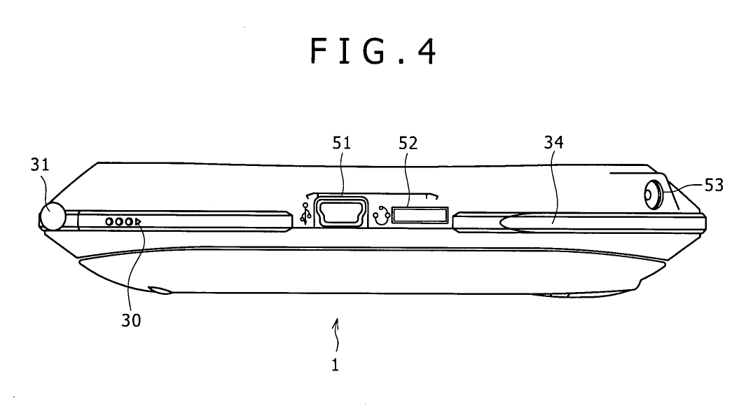

FIG. 4 is a diagram showing the top view of the external appearance of the information communication terminal. In this case, the top is defined as the side having the WLAN on/off switch 30.

As shown in the figure, the top of the information communication terminal 1 includes a USB connector 51, a connector jack 52 and a DC jack 53.

A USB cable is connected to the USB connector 51, allowing the information communication terminal 1 to exchange information with another apparatus. As the USB connector 51, it is demanded to provide at least a downstream-side connector, and an upstream-side connector may be provided. The downstream-side connector is the so-called series-B or series-mini-B connector for connecting the information communication terminal 1 to the personal computer 13. On the other hand, the upstream-side connector is the so-called series-A connector for connecting the information communication terminal 1 to a peripheral apparatus. In addition, the information communication terminal 1 can receive a power supply via a USB connection.

The connector jack 52 is typically a 10-pin flat connector for connecting the information communication terminal 1 to an audio input/output device such as a headphone or a mike.

The DC jack 53 is used for receiving power of a DC power supply. In general, the DC jack 53 is connected to an AC/DC converter for converting the 100V AC power generated by the home power supply into a DC power supplied to the information communication terminal 1.

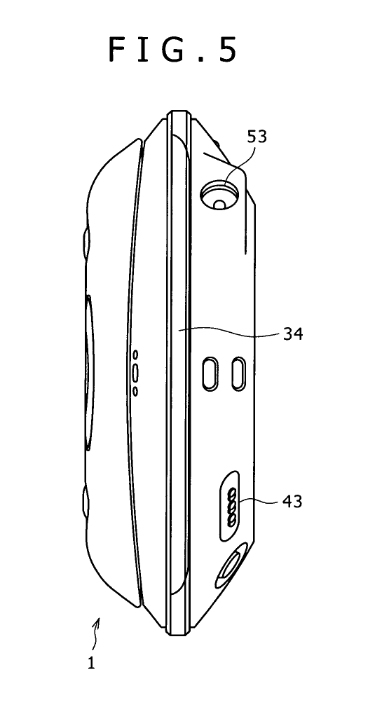

FIG. 5 is a diagram showing the right-side view of the external appearance of the information communication terminal 1. In this case, the right side is defined as the side located in the right when seen from a position at which the display unit 21 of the information communication terminal 1 is visible or, in other words, the right side is defined as the side having a communication-state notification light emitting unit 34.

As shown in FIG. 5, the right-side face of the information communication terminal 1 also includes the hold switch 43 and the DC jack 53 in addition to the communication-state notification light emitting unit 34.

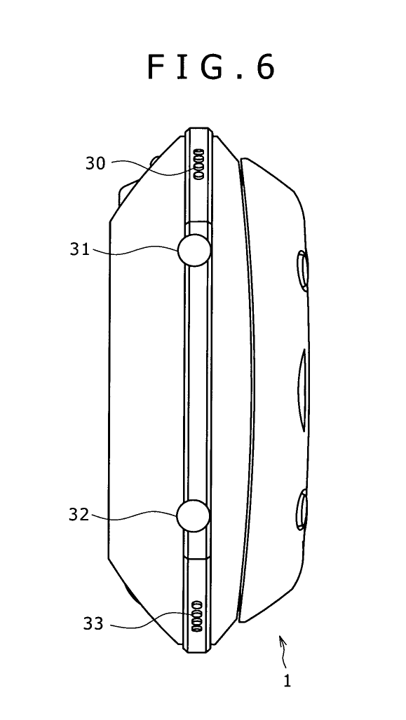

FIG. 6 is a diagram showing the left-side view of the external appearance of the information communication terminal 1. In this case, the left side is defined as the side located in the left when seen from a position at which a display unit 21 of the information communication terminal 1 is visible or, in other words, the right side is defined as the side having the WLAN on/off switch 30 and the power-supply switch 33.

As shown in FIG. 6, the left-side face of the information communication terminal 1 also includes the WLAN-state notification light emitting unit 31 and the power-supply-state notification light emitting unit 32 in addition to the WLAN on/off switch 30 and the power-supply switch 33.

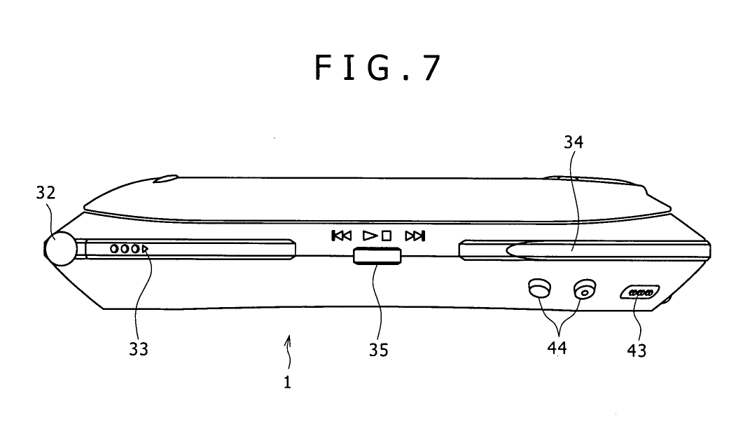

FIG. 7 is a diagram showing the bottom view of the external appearance of the information communication terminal 1. In this case, the bottom is defined as the side having the power-supply switch 33 and the music key 35.

As shown in FIG. 7, the bottom of the information communication terminal 1 also includes the power-supply-state notification light emitting unit 32, the communication-state notification light emitting unit 34, the hold switch 43 and the volume button 44 in addition to the power-supply switch 33 and the music key 35.

The information communication terminal 1 is configured to allow the cover 61 of the front face to be slid in the upward direction. As described earlier, the cover 61 has the display unit 21, the WLAN-mode switching button 22, the home button 23, the back button 24, the option button 25, the 4-direction keys 26, the enter button 27, the speaker 28 and the mike 29. The upward direction is an upward direction seen at a position in front of the display unit 21. With the cover 61 sled upward, a keyboard 71 is exposed to the user. FIG. 8 is a diagram showing the front view of the external appearance of the information communication terminal 1 with its front cover 61 slid upward.

FIG. 9 is a diagram showing an external appearance of the inside of the keyboard 71 employed in the information communication terminal 1.

Internal components inside the keyboard 71 employed in the information communication terminal 1 includes light emitting devices 81, 82 and 84 as well as light guide tubes 83 and 85. The light emitting device 81 serves as a WLAN-state notification light emitting device 31 and the light emitting device 82 serves as a power-supply state notification light emitting device 32. The light guide tube 83 serves as the WLAN-state notification light emitting device 31 and the power-supply state notification light emitting device 32. The light emitting device 84 serves as a communication-state notification light emitting device 34.

The light emitting devices 81 and 82 are provided on the edge faces of the arc of the light guide tube 83 so that a light beam can be introduced to the inside of the light guide tube 83 effectively. In addition, by placing the light emitting devices 81 and 82 at locations immediately following the white printing of the light guide tube 83, the light guide tube 83 can be driven to emit a light beam through the white printing.

The light guide tube 83 is made typically of transparent polycarbonate and is attached to an external case by carrying out an ultrasonic wave welding process in order to realize both strength and good appearance. At positions adjacent to the light guide tube 83, a WLAN on/off switch 30 and a power-supply switch 33 are provided. The WLAN on/off switch 30 and the power-supply switch 33 are each a switch having the same texture as the light guide tube 83. Thus, the light guide tube 83, the WLAN on/off switch 30 and the power-supply switch 33 can have the same design texture and it is possible to implement a user interface making the user capable of easily recognizing that the nearby light emitting devices 81 and 82 emit light when the WLAN on/off switch 30 and the power-supply switch 33 are turned on.

The rear face of the light guide tube 83 is a white-color printed face. The white rear face reflects light to enable the light guide tube 83 to emit light to a wide range and, also when the light emitting devices 81 and 82 are not emitting light, the light emitting devices 81 and 82 are not visible from an external position. In order to assure an optical path in the light guide tube 83, the shape of the light guide tube 83 is made to resemble the shape of an arc with a lenient curvature. The shape of a portion included in the light guide tube 83 as a portion visible from the bearer of the light guide tube 83 is also made flat so as to prevent the light emission from becoming non-uniform. In addition, by forming the shape of the light guide tube 83 into a C face, the C face reflects light, improving visual recognizability of the light emission.

The light emitting device 84 is provided on the edge face of the arc of the light guide tube 85 so that a light beam can be introduced to the inside of the light guide tube 85 effectively. In addition, by placing the light emitting device 84 at a location immediately following the white printing of the light guide tube 85, the light guide tube 83 can be driven to emit a light beam through the white printing.

The light guide tube 85 is made typically of transparent polycarbonate and is attached to an external case by carrying out an ultrasonic wave welding process in order to realize both strength and good appearance. The rear face of the light guide tube 85 is a white-color printed face. The white rear face reflects light to enable the light guide tube 85 to emit light to a wide range and, also when the light emitting device 84 is not emitting light, the light emitting device 84 is not visible from an external position. In order to assure an optical path in the light guide tube 85, the shape of the light guide tube 85 is made to resemble the shape of an arc with a lenient curvature. The shape of a portion included in the light guide tube 85 as a portion visible from the bearer of the light guide tube 85 is also made flat so as to prevent the light emission from becoming non-uniform. In addition, by forming the shape of the light guide tube 85 into a C face, the C face reflects light, improving visual recognizability of the light emission.

The following description explains operation inputs related to the power supply and the WLAN as well as the states of the light emitting units explained above by referring to FIGS. 2 to 9.

First of all, with the power supply of the information communication terminal 1 put in an off state, the light emitting units including the power-supply-state notification light emitting unit 32 do not emit light either. Then, let us assume that the power-supply switch 33 is turned on in order to change the state of the power supply from the off state to an on state. In this case, the power-supply-state notification light emitting unit 32 emits light having a predetermined color indicating that the power supply has been put in the on state. In this state, the information communication terminal 1 is capable of accepting a normal operation input entered by the user.

With the power supply of the information communication terminal 1 put in an on state, that is, with the power-supply-state notification light emitting unit 32 put in a state of emitting light having a predetermined color indicating that the power supply has been put in the on state, the WLAN is still in an off state indicated by the WLAN-state notification light emitting unit 31 also being in an off state as well. In order to change the state of the WLAN from the off state to an on state, the user needs to operate the WLAN on/off switch 30. Typically, the WLAN on/off switch 30 is a slide-type switch to be slid in order to put the WLAN in an on or off state. In this case, the user can slide the WLAN on/off switch 30 in a predetermined direction in order to change the state of the WLAN from the off state to an on state. When the user slides the WLAN on/off switch 30 in the predetermined direction in order to change the state of the WLAN from the off state to the on state, the information communication terminal 1 is put in a state of being capable of carrying out a radio communication through the WLAN. In this state, the WLAN-state notification light emitting unit 31 is emitting light.

When the WLAN on/off switch 30 is operated in order to start a radio communication as described above, the information communication terminal 1 gets into a communication mode, which can be a WLAN infrastructure mode or a WLAN ad-hoc mode. Either the WLAN infrastructure mode or the WLAN ad-hoc mode is selected as the communication mode in accordance with setting. As an alternative, the information communication terminal 1 gets into the WLAN infrastructure mode or the WLAN ad-hoc mode, which was selected last as the communication mode.

The communication-state notification light emitting unit 34 is emitting light having a color determined on the basis of whether the present communication mode of the information communication terminal 1 is the WLAN infrastructure mode or the WLAN ad-hoc mode. In addition, the communication-state notification light emitting unit 34 emits light after the WLAN-state notification light emitting unit 31 emits light without regard to the state of the connection of the information communication terminal 1 to the WLAN. As an alternative, the communication-state notification light emitting unit 34 emits light only after such a connection has been established. On top of that, the communication-state notification light emitting unit 34 may emit light with an intensity determined by the strength of an electric wave received by the information communication terminal 1.

With the power supply of the information communication terminal 1 put in an on state, that is, with the power-supply-state notification light emitting unit 32 put in a state of emitting light having a predetermined color indicating that the power supply has been put in the on state and with the WLAN infrastructure mode selected as the communication mode, whereas the communication-state notification light emitting unit 34 put in a state of emitting light having a predetermined color indicating that the WLAN infrastructure mode has been selected as the communication mode, the user may want to change the communication mode from the WLAN infrastructure mode to the WLAN ad-hoc mode. In this case, the user needs to operate the WLAN-mode switching button 22. For example, the user presses the WLAN-mode switching button 22 downward in order to change the communication mode from the WLAN infrastructure mode to the WLAN ad-hoc mode. As a result, the communication mode is changed from the WLAN infrastructure mode to the WLAN ad-hoc mode indicated by the communication-state notification light emitting unit 34 emitting light with its color changed from the color indicating that the WLAN infrastructure mode has been selected as the communication mode to a predetermined color indicating that the WLAN ad-hoc mode has been selected as the communication mode.

With the WLAN ad-hoc mode selected as the communication mode of the information communication terminal 1, that is, with the WLAN-state notification light emitting unit 31 emitting light and the communication-state notification light emitting unit 34 emitting light having a predetermined color indicating the WLAN ad-hoc mode has been selected as the communication mode of the information communication terminal 1, let us assume that the user wants to switch the communication mode from the WLAN ad-hoc mode to the WLAN infrastructure mode. In this case the user needs to operate the WLAN-mode switching button 22. When the user operates the WLAN-mode switching button 22, the communication mode of the information communication terminal 1 is switched from the WLAN ad-hoc mode to the WLAN infrastructure mode as evidenced by the communication-state notification light emitting unit 34 emitting light with its color changed from the color indicating that the WLAN ad-hoc mode has been selected as the communication mode to a predetermined color indicating that the WLAN infrastructure mode has been selected as the communication mode.

With the power supply of the information communication terminal 1 put in an on state, that is, with the power-supply-state notification light emitting unit 32 put in a state of emitting light having a predetermined color indicating that the power supply has been put in the on state, let us assume that the user wants to turn of the WLAN off. In this case, the user needs to operate the WLAN on/off switch 30. Typically, the WLAN on/off switch 30 is a slide-type switch to be slid in order to put the WLAN in an on or off state. In this case, the user can slide the WLAN on/off switch 30 in a predetermined direction in order to change the state of the WLAN from the on state to an off state. When the user slides the WLAN on/off switch 30 in the predetermined direction in order to change the state of the WLAN from the on state to the off state, the information communication terminal 1 is put in a state of being no longer capable of carrying out a radio communication through the WLAN. In this state, the WLAN-state notification light emitting unit 31 is not emitting light anymore.

If the communication-state notification light emitting unit 34 emits light after the WLAN-state notification light emitting unit 31 emits light without regard to the state of the connection of the information communication terminal 1 to the WLAN, the communication-state notification light emitting unit 34 stops emitting light after the WLAN-state notification light emitting unit 31 ceases to emit light. If the communication-state notification light emitting unit 34 emits light after the connection of the information communication terminal 1 to the WLAN has been established, on the other hand, the communication-state notification light emitting unit 34 stops emitting light after the connection is cut off even if the WLAN is still an on state. The communication-state notification light emitting unit 34 also stops emitting light as the WLAN-state notification light emitting unit 31 ceases to emit light when the WLAN is turned off with the connection of the information communication terminal 1 to the WLAN established.

The power supply can be in one of two different off states. One of the two off state is referred to as a first power-supply off state or a user off state. The power supply is put in the first power-supply off state when the user turns off the power supply and no operation input is entered by the user within three days after the user turns off the power supply. In the first power-supply off state, however, power is supplied to a processor to be described later so that, when the user turns on the power supply with the power supply put in the first power-supply off state, the information communication terminal 1 can be activated immediately.

The other off state is referred to as a second power-supply off state or a deep off state. The power supply is put in the second power-supply off state when the user turns off the power supply and no operation input is entered by the user even after the lapse of three consecutive days since the user turns off the power supply. In the second power-supply off state, no power is supplied to the processor to be described later so that, when the user turns on the power supply with the power supply put in the second power-supply off state, it takes time of a predetermined length such as 30 seconds to put the information communication terminal 1 in a state of being ready for activation.

The information communication terminal 1 can be electrically charged by putting the information communication terminal 1 in a USB-connected state by making use of the USB connector 51 or by supplying DC power to the information communication terminal 1 by way of the DC jack 53. In general, the DC jack 53 is connected to an AC/DC converter for converting the 100V AC power generated by the home power supply into a DC power supplied to the information communication terminal 1. While the information communication terminal 1 is being electrically charged, the power-supply-state notification light emitting unit 32 is emitting light having a predetermined color indicating that the information communication terminal 1 is being electrically charged.

The following description explains the continuous display panel 101, which is basically displayed on the display unit 21 all the time.

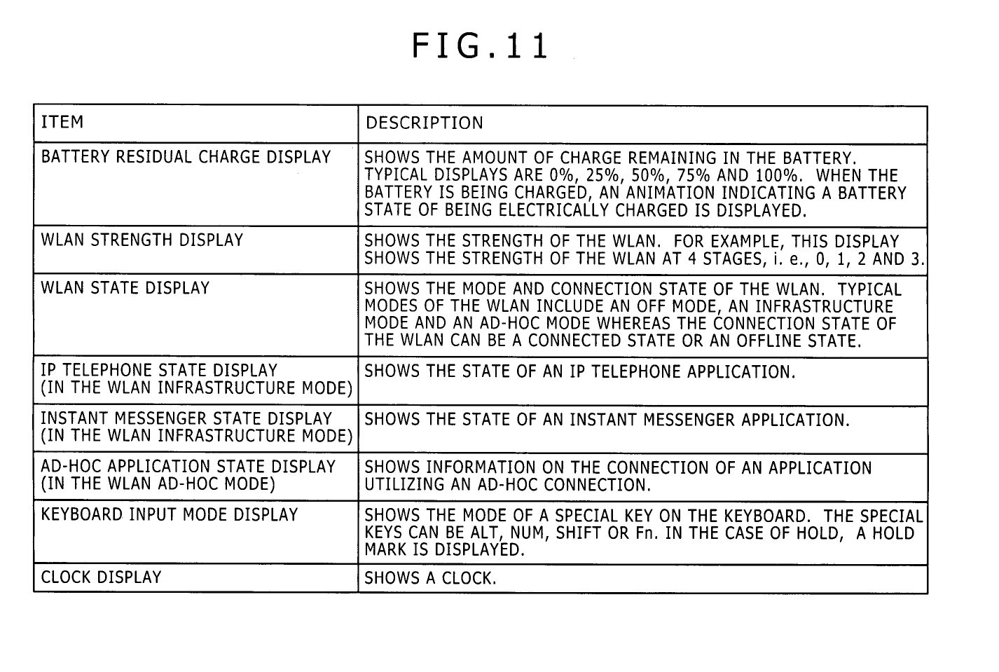

As shown in FIG. 10, the continuous display panel 101 appears typically in a predetermined area stretched along the bottom line of the display unit 21. Basically, the continuous display panel 101 appears all the time. The continuous display panel 101 shows various kinds of information such as ones described in FIG. 11 as information on the state of the information communication terminal 1.

For example, the continuous display panel 101 includes a battery residual charge amount display area 111, a WLAN wave-strength display area 112, a WLAN state display area 113, a communication utilization application state display area 114, a keyboard input mode display area 115 and a clock display area 116.

The battery residual charge amount display area 111 is an area for showing information on the amount of electrical charge left in a battery. Typical displays in the battery residual charge amount display area 111 are 0%, 25%, 50%, 75% and 100%. When the battery is being charged, an animation indicating a battery state of being electrically charged is displayed.

The WLAN wave-strength display area 112 is an area for showing information on the strength of the WLAN. To put it concretely, this display typically shows the strength of the WLAN at four stages, i.e., 0, 1, 2 and 3.

The WLAN state display area 113 is an area for showing information on the mode and connection state of the WLAN. To put it concretely, the WLAN state display area 113 typically displays a WLAN mode such as an off mode, the WLAN infrastructure mode and the WLAN ad-hoc mode as well as a WLAN connection state such as a connected state (or a state of being connected) or an offline state.

The communication utilization application state display area 114 is an area for showing information on the state of execution of an Application carrying out a communication in either the WLAN infrastructure mode or the WLAN ad-hoc mode. Specifically, for example, in the WLAN infrastructure mode, if an IP telephone application is executed in order to carrying out a communication, the state of execution of the IP telephone application is shown in the communication utilization application state display area 114. If an instant messenger application is executed in order to carry out a communication in the WLAN infrastructure mode, the communication utilization application state display area 114 shows the state of execution of the instant messenger application. If an application making use of ad-hoc connection is executed in the WLAN ad-hoc mode, on the other hand, the communication utilization application state display area 114 shows connection information of the WLAN ad-hoc mode. An example of the connection information of the WLAN ad-hoc mode is information on whether or not a one-to-one communication is going on.

The keyboard input mode display area 115 is an area for showing information on the input mode of a special key on the keyboard. The special keys include Alt, Num, Shift and Fn. In the case of Hold, a Hold mark is displayed in the keyboard input mode display area 115.

The clock display area 116 is an area for showing information generated by a clock.

Let us keep in mind that it is needless to say that the continuous display panel 101 may also display various kinds of information on the states of the information communication terminal 1 other than the pieces of information described above.

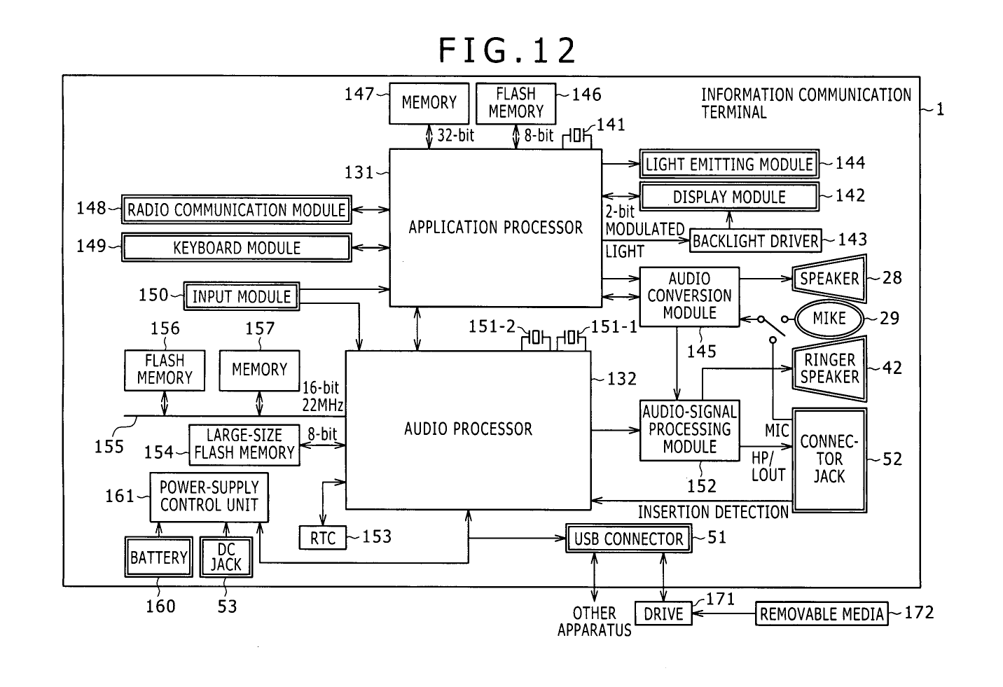

FIG. 12 is a block diagram showing the internal configuration of the information communication terminal 1.

The information communication terminal 1 includes an application processor 131 and an audio processor 132. The application processor 131 is a processor used mainly for executing an application program. On the other hand, the audio processor 132 is a processor for executing functions such as management of audio data, coding and decoding of audio data and management of copyrights. The application processor 131 and the audio processor 132 are connected to each other typically by making use of one serial interface or one parallel interface or a plurality of serial or parallel interfaces so that the application processor 131 and the audio processor 132 are capable of exchanging control signals and data with each other.

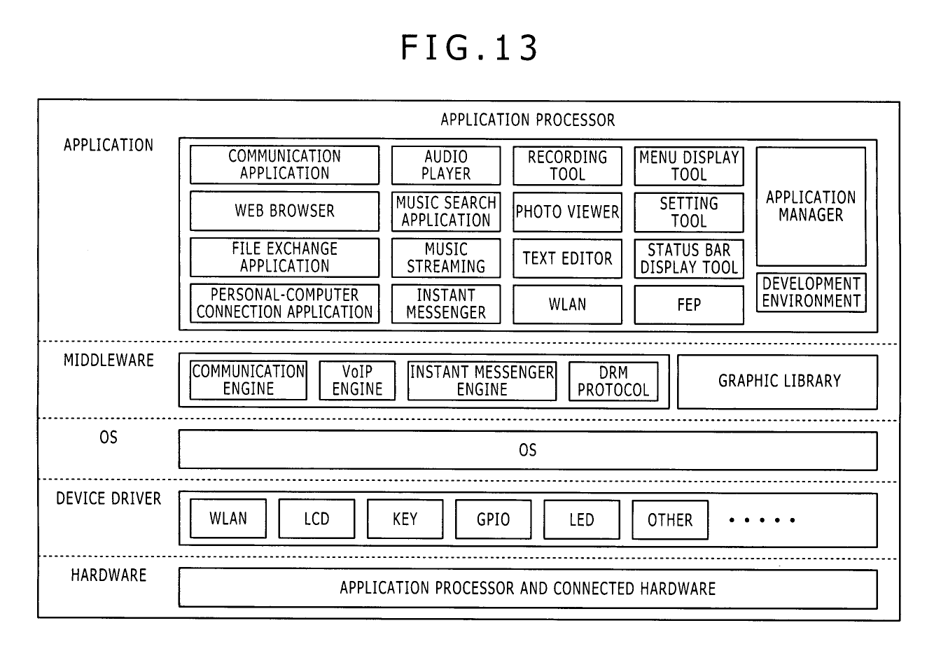

The application processor 131 carries out various kinds of processing on the basis of a clock signal generated by a clock generation unit 141. Details of functions carried out by the application processor 131 will be described later by referring to FIG. 13.

The application processor 131 is connected to a display module 142, a backlight driver 143, a light emitting module 144, an audio conversion module 145, a flash memory 146, a memory 147, a radio communication module 148, a keyboard module 149 and an input module 150. The input module 150 is also connected to the audio processor 132.

The display module 142 is configured to include the display unit 21. If an LCD unit is employed as the display unit 21, the display module 142 is configured to also include an LCD driver, an LCD backlight and, if necessary, components such as a light guide plate required in an operation to display information on the display unit 21. The display module 142 displays various kinds of information on the display unit 21 in accordance with control executed by the application processor 131.

The backlight driver 143 is a driver for the backlight of the display unit 21.

The light emitting module 144 includes the WLAN-state notification light emitting unit 31, the power-supply-state notification light emitting unit 32, the communication-state notification light emitting unit 34 and drivers for driving light emitting devices employed in the WLAN-state notification light emitting unit 31, the power-supply-state notification light emitting unit 32 and the communication-state notification light emitting unit 34. The light emitting module 144 puts the WLAN-state notification light emitting unit 31, the power-supply-state notification light emitting unit 32 and the communication-state notification light emitting unit 34 in an on, blinking or off state in accordance with control executed by the application processor 131. In the on and blinking states, the WLAN-state notification light emitting unit 31, the power-supply-state notification light emitting unit 32 and the communication-state notification light emitting unit 34 each emit light having a predetermined color.

The audio conversion module 145 includes embedded components such as a PLL circuit, an A/D converter, a D/A converter and a DSP core. The audio conversion module 145 is capable of carrying out filter processing and equalizer processing. The filter processing includes processing of a high-pass filter and a notch filter. To be more specific, in accordance with control executed by the application processor 131, the audio conversion module 145 carries out an A/D conversion process on a sound input by the mike 29 or a mike connected to the connector jack 52, and carries out predetermined processing such as filtering on the result of the process. Then, the audio conversion module 145 supplies the result of the predetermined processing to the application processor 131. On the other hand, the audio conversion module 145 carries out a D/A conversion process on audio data received from the application processor 131 and outputs the result of the D/A conversion process to the speaker 28 as a reproduced sound, or outputs audio data obtained as a result of the D/A conversion process to typically a headphone connected to the connector jack 52 as a reproduced sound by way of the connector jack 52.

The flash memory 146 is a memory having a typical storage capacity of about 64 MB. The flash memory 146 is used for storing programs to be executed by the application processor 131 and information that remains stored in the flash memory 146 even after the power supply is put in an off state. The information stored in the flash memory 146 includes data and a variety of register variables. The data and the register variables are information required in the execution of the programs.

The memory 147 is typically an SDRAM (Synchronous Dynamic Random Access Memory) having a typical storage capacity of about 64 MB. The memory 147 is used for storing information required in processing carried out by the application processor 131.

The radio communication module 148 is a unit for implementing a WLAN function conforming to the 802.11b standard. In accordance with control executed by the application processor 131, the radio communication module 148 carries out a radio communication in order to exchange information with another apparatus directly or through an access point and a network.

The keyboard module 149 is configured to include the keyboard 71 for receiving an operation input entered by the user and supplying a signal representing the operation to the application processor 131.

The input module 150 is configured to include the WLAN-mode switching button 22, the home button 23, the back button 24, the option button 25, the 4-direction keys 26, the enter button 27, the WLAN on/off switch 30, the power-supply switch 33, the music key 35, the hold switch 43 and the volume button 44. The input module 150 is a module for receiving an operation input entered by the user and supplying a signal representing the operation to the application processor 131 or the audio processor 132.

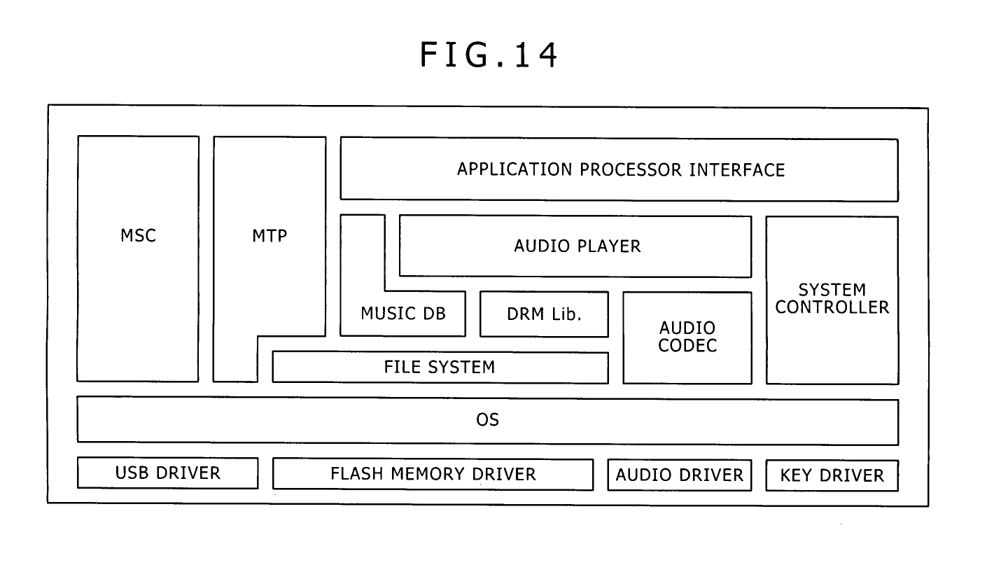

The audio processor 132 carries out various kinds of processing on the basis of a clock signal generated by a clock generation unit 151-1 or a clock generation unit 151-2. Since the audio processor 132 is a processor for handing mainly audio data, it is proper for the audio processor 132 to use two different clock signals. One of the clock signals is a basic clock signal used for processes such as processing to code and decode audio data. The other clock signal is a basic clock signal used for other signal processing. Functions carried out by the audio processor 132 will be described in detail by referring to FIG. 14.

The audio processor 132 is connected to the input module 150 described above, an audio-signal processing module 152, the USB connector 51, a real-time clock (RTC) 153, a large-capacity flash memory 154 and a memory bus 155. The memory bus 155 is connected to a flash memory 156 and a memory 157. The audio processor 132 also receives a signal indicating whether a device such as a headphone has been inserted into the connector jack 52 or pull out from the connector jack 52.

The audio-signal processing module 152 includes embedded components such as a D/A converter, a digital filter and an audio output amplifier for the headphone or the speaker. The audio-signal processing module 152 carries out a D/A conversion process on audio data received from the audio processor 132 or the audio conversion module 145, carries out a filtering process on the result of the D/A conversion process if necessary, amplifies the result of the filtering process and supplies the output of the amplifier to the ringer speaker 42 or the connector jack 52 as a reproduced signal. In addition, the audio-signal processing module 152 also receives a command from the audio processor 132 as a command to output not only an audio signal, but also the so-called beep sound or a calling sound of typically an arriving IP telephone call. The audio-signal processing module 152 outputs the beep sound or the calling sound of an arriving IP telephone call to the ringer speaker 42 or the connector jack 52.

The real-time clock (RTC) 153 is a clock for finding the present time by counting the number of pulses output by a pulse generator and supplying the present time to the audio-signal processing module 152.

The large-capacity flash memory 154 is a flash memory having a typical large storage capacity of 1 GB. The large-capacity flash memory 154 is used for storing information received from the audio processor 132. It is to be noted that the large-capacity flash memory 154 is also used for storing information generated by or acquired from a process carried out by the application processor 131 and supplied by the application processor 131 to the large-capacity flash memory 154 by way of the audio processor 132.

In addition, the large-capacity flash memory 154 is also used for storing information on other registered users. The information on another registered user is used in a process to exchange information with the other user by making use of an exchange tool such as an instant messenger, an IP phone, chatting or an email. The information exchanged with the other user typically includes a content such as musical data reproducible in a process carried out by the audio processor 132 and data generated as a result of executing a variety of application programs.

The flash memory 156 is typically a memory having a typical storage capacity of about 64 MB. The flash memory 156 is used for storing a program to be executed by the audio processor 132 and information that remains stored in the flash memory 156 even after the power supply is put in an off state. The information stored in the flash memory 156 includes data and a variety of register variables. The data and the register variables are information required in the execution of the program.

The memory 157 is typically an SDRAM (Synchronous Dynamic Random Access Memory) having a typical storage capacity of about 64 MB. The memory 157 is used for storing information required in processing carried out by the audio processor 132.

The USB connector 51 is connected to an external apparatus by making use of a USB cable. An example of the external apparatus is the personal computer 13 explained before by referring to FIG. 1. If necessary, the USB connector 51 is also connected to a drive 171 on which a removable medium 172 is mounted. Examples of the removable medium 172 are a magnetic disk, an optical disk, a magneto-optical disk and a semiconductor memory. If necessary, a computer program read out from the removable medium 172 is installed in the flash memory 146 or the flash memory 156 in an executable state.

A signal received from an external apparatus such as the personal computer 13 through the USB connector 51 is supplied to the audio processor 132 and, if necessary, supplied to the application processor 131. On the other hand, the audio processor 132 outputs a predetermined signal to the external apparatus such as the personal computer 13 by way of the USB connector 51.

DC power supplied through the USB connection, DC power supplied through the DC jack 53 or DC power supplied from a battery 160 mounted on the information communication terminal 1 is distributed to components composing the information communication terminal 1 by a power-supply control unit 161.

FIG. 13 is a software-stack diagram showing the configuration of software executed by the application processor 131.

As shown in FIG. 13, the configuration of the software to be executed by the application processor 131 includes the following layers: a hardware layer at the bottom of the configuration, a device-driver layer above the hardware layer, an OS layer above the device-driver layer, a middleware layer above the OS layer and an application layer on the top of the configuration.

The device-driver layer is dedicated software for driving the application processor 131 and hardware connected to the application processor 131. To put it concretely, the device-driver layer includes a WLAN device driver WLAN for driving the radio communication module 148, an LCD driver for driving LCDs employed in the display module 142 for displaying an image on the display unit 21, a KEY keyboard driver for driving the keyboard module 149, a GPIO device driver for driving general-purpose ports of the application processor 131 and an LED driver for driving light emitting diodes employed in the WLAN-state notification light emitting unit 31, the power-supply-state notification light emitting unit 32 and the communication-state notification light emitting unit 34, which are included in the light emitting module 144.

In addition, the device-driver layer also properly includes other required device drivers such as a device driver for driving the backlight driver 143, a variety of memory drivers, a device driver for driving the audio conversion module 145, a mouse driver for driving a mouse if a mouse is employed in the information communication terminal 1 as an input device, a hard-disk driver for driving an embedded hard disk used for storing information if the hard disk is embedded in the information communication terminal 1 and a printer driver for driving an external printer connected to the information communication terminal 1 as an output device to which the information communication terminal 1 outputs information to be printed.

The OS layer is an OS (operating system) for controlling basic operations of the application processor 131. The OS is a basic program for managing a variety of resources driven by the device drivers. The OS manages the entire system by providing basic functions common to a number of application programs on the middleware and application layers to be described later as functions available to middleware and the application programs. For example, when any of the application programs executes an instruction, a device driver associated with the instruction is activated to carry out an operation requested by the instruction. Examples of the operation carried out by the device driver are an operation to input or output data from or to the flash memory 146, the memory 147 or the audio processor 132 and an operation to execute management of input/output functions such as a function to input data from the keyboard and a function to output an image to a screen. The OS can be Windows (a registered trademark) 95 (a trademark), Windows (a registered trademark) 98 (a trademark), Windows (a registered trademark) NT (a trademark), LINUX or OS/2 (a trademark). In addition, the OS also manages some software resources included typically in a context of execution of an application program on the application layer to be described later. The context of execution of an application program includes a set of registers, a main-memory image and a file handler.

Executed on the OS, the middleware on the middleware layer provides application programs with functions more sophisticated and more practical than the functions offered by the OS.

The middleware thus has an intermediate characteristic between the OS and application programs. If a function common to a number of application programs is developed individually for each of the application programs, the software development will become inefficient. In order to solve this problem, such a common function to be used by the application programs is developed as a function of the middleware. Thus, the middleware is a collection of such common functions, which are each generally a basic function in many cases.

To put it concretely, the middleware includes software elements such as a communication engine, a VoIP (Voice over IP) engine, an instant-messenger engine, a DRM (Digital Rights Management) protocol and a graphic library. The communication engine is software for providing basic functions of communication applications such as the IP phone. The VoIP engine is software for providing basic functions of a technology for exchanging audio data by making use of a TCP/IP network such as the Internet or an intranet. The instant-messenger engine is software for providing basic functions of an instant messenger. The DRM protocol is software for realizing a function for implementing processes such as a process to encrypt digital data in order to protect the copyright of the digital data. The graphic library is a collection of GUI components to be displayed on the display unit 21 to accompany execution of a variety of application programs.

To be more specific, the graphic library is a collection of general-purpose functions and general-purpose data, which are to be used in image processing carried out by a variety of application programs executed on the application layer. To put it more concretely, the graphic library is used for collecting some general-purpose functions to be used in the image processing in the same way as a book room is used for collecting books. That is to say, functions necessary for execution of application programs are made sharable by the programs as an independent file referred to as a graphic library. In general, the graphic library is loaded at an execution time separately from an application program and distinguished from subroutines of an application program.

On the application layer at the top of the software configuration, a variety of application programs are executed. In case of the information communication terminal 1, the application programs include application software, utilities, an application manager and a development environment. The application software includes individual applications such as a communication application, a web browser, a file exchange application, a personal-computer connection application, an audio player, a music search application, a music streaming application, an instant messenger, a recording tool, a photo viewer and a text editor. The utilities include a WLAN interface, a menu display tool, a setting tool, a status-bar display tool and an FEP (Front End Processor). The application manager is a program for managing the application software.

The communication application is an application program making use of the communication engine and the VoIP engine to allow the user to communicate with (a user utilizing) another apparatus through the so-called IP telephone function or a voice chatting function.

The web browser is an application used for viewing a web page through a network. To put it concretely, the web browser implements functions to download a file such as an HTML file, an image file or a musical file from a web server through the network and analyze the layout of the page in order to display/reproduce the file. The web browser also implements a function of allowing the user to transmit data to the web server by making use of a displayed form. In addition, the web browser also implements a function to execute application software written in a language such as Java (a trademark) Script, Flash or Java (a trademark).

The file exchange application is an application program having a file transfer function to exchange a data file with another apparatus connected to the information communication terminal 1 through a network or directly. The personal-computer connection application is an application program having a function to connect the information communication terminal 1 to the personal computer 13 in order to allow the information communication terminal 1 to exchange information with the personal computer 13.

The audio player is an application program having a function to reproduce musical data. The music search application is an application program having a function to store audio data in an internal database and allow the user to search the database for desired musical data. The music streaming application is an application program having a function to transmit multimedia data such as video and audio data to another apparatus through a network and reproduce multimedia data in a streaming reproduction process while receiving the data from another apparatus through the network.

The instant-messenger application is an application program having a function to produce a result of determination as to whether or not a peer connected to the network such as the Internet or a LAN as a peer making use of the same software is in an online state. The instant-messenger application also has a function to allow chatting with the peer or a transfer of a file to/from the peer if the result of the determination indicates that the peer is in an online state.

The recording tool is an application program having a function to record audio data input by the mike 29 in a way similar to the so-called voice memo and reproduce the recorded audio data. The photo viewer is an application program having a function to manage image data (or photo data) recorded internally in the information communication terminal 1 and control a process to reproduce and display the recorded image data by making use of a variety of display methods such as a method to display image data as a list of thumbnail images and a slideshow display method. The text editor is an application program having a function to create text data on the basis of operation inputs entered by the user via an input device such as the keyboard 71.

Individual application programs other than those mentioned and described above include table-calculation software, database creation software, an email application and a variety of game applications. These other application programs can also be properly installed in the information communication terminal 1 as well.

The WLAN interface is a utility for implementing a WLAN function conforming typically to the 802.11b standard. The menu display tool is a utility for controlling a display appearing on the display unit 21 as a display showing information such as a menu or a standby image. The setting tool is a utility for setting a variety of functions of the information communication terminal 1 on the basis of operation inputs entered by the user. The status-bar display tool is a utility for displaying various kinds of information on the continuous display panel 101 explained earlier by referring to FIGS. 10 and 11. The FEP is a utility serving as kanji conversion software used for handing inputs entered in the Japanese language.

FIG. 14 is a software-stack diagram showing the configuration of software executed by the audio processor 132.

The device-driver layer at the bottom of the configuration is dedicated software for driving the audio processor 132 and hardware connected to the audio processor 132. To put it concretely, the device-driver layer includes a USB driver, a flash-memory driver, an audio driver and a key driver. The USB driver is a device driver for implementing USB-connection and USB-streaming functions. The flash-memory driver is a device driver for driving the large-capacity flash memory 154 connected to the audio processor 132. The audio driver is a device driver for driving the audio-signal processing module 152. The key driver is a device driver for driving an input device employed in the input module 150. An example of the input device is a music key 35 for inputting an operation input concerning a process to be carried out by the audio processor 132.

The device-driver layer may also properly include other required device drivers such as a memory driver for driving a memory other than the large-capacity flash memory 154 and a GPIO device driver for driving a general-purpose port of the application processor 131.

The OS is a basic program for controlling basic operations carried out by the audio processor 132. As the OS of the audio processor 132, it is desirable to employ a real-time OS designed for an embedded system. An example of the real-time OS designed for an embedded system is uITRON.

A variety of application programs are executed on the OS.

In implementing USB connection, the information communication terminal 1 is capable of switching a USB mode from an MSC (Mass Storage Class) mode, which is one of two USB modes, to an MTP (Media Transfer Protocol) mode serving as the other USB mode and vice versa.

The MSC (Mass Storage Class) mode is a USB mode providing the host apparatus with a function to recognize and control a connected USB apparatus as a storage apparatus. In this case, the USB apparatus is the information communication terminal 1 connected to the personal computer 13. That is to say, having a MSC (mass storage class) interface, the information communication terminal 1 is recognized as a driver by an OS running on the personal computer 13. Thus, an application executed in the personal computer 13 is capable of reading out data stored internally in the information communication terminal 1. The data stored internally in the information communication terminal 1 includes image data and musical data. The application executed in the personal computer 13 to read out data stored internally in the information communication terminal 1 is not limited to a special application, but may also be an explorer or the like.

The MTP (Media Transfer Protocol) mode is a USB mode providing a protocol for connecting the information communication terminal 1 and the personal computer 13 to each other and exchanging musical data, moving-picture data and still-picture data between the information communication terminal 1 and the personal computer 13. MTP software for the MTP mode is executed on a layer of communication with any storage device including the USB MSC (mass storage class) storage apparatus, allowing a content having a copyright protection flag to be transferred with a high degree of safety.

A file system is software for managing files stored in a memory (such as the large-capacity flash memory 154) connected to the audio processor 132. Some of the files managed by the file system are stored in a database. To be more specific, musical-data files managed by the file system are stored in a musical DB (database). The copyrights of the musical-data files are protected in a DRM (Data Rights Management) library.

The DRM library is a collection of general-purpose functions and general-purpose data, which are used by a variety of application programs to encrypt digital data such as musical data, moving-picture data and still-picture data in order to implement a function of avoiding illegal data copies and illegal transfers of data to other apparatus.

Musical data stored in a memory (such as the large-capacity flash memory 154) connected to the audio processor 132 is data compressed by an audio coding/decoding unit in a compression format such as an MP3 (MPEG Audio layer-3) format, an ATRAC3 (Adaptive TRansform Acoustic Coding-3) format, a WMA (Windows (a trademark) Media Audio) format or an ASF (Advanced Streaming Format). Thus, the audio coding/decoding unit is also capable of decompressing the compressed musical data by adoption of a decompression method for the compression format.

An audio player is software for controlling a process to decompress compressed audio data in the audio coding/decoding unit by adoption of a predetermined decompression method and output the audio data as reproduced data. The compressed audio data to be decompressed is supplied to the audio processor 132 by way of an application processor interface. The compressed audio data is audio data subjected to copyright protection based on the DRM library and managed by making use of the musical DB in accordance with control signals output by various kinds of software executed by the application processor 131.

A system controller is software for controlling a variety of functions implemented by the audio processor 132.

An application processor interface is software for providing a function to control exchanges of various kinds of information and control signals between the application processor 131 and the audio processor 132.

By referring to display screens appearing on the display unit 21, the following description explains typical and concrete executions of a variety of application programs in the information communication terminal 1.

A variety of application programs executed by the information communication terminal 1 can be classified into a category not making use of processing of communications with another apparatus and a category making use of processing of communications with another apparatus through a network. The category not making use of processing of communications with another apparatus includes the audio player, the recording tool (or the so-called voice memo tool), the photo viewer and the text editor. As described earlier, the audio player is an application program for reproducing audio data. On the other hand, the category making use of processing of communications with another apparatus includes the file exchange application, the music streaming application, the communication application, the instant messenger and the web browser. As described before, the file exchange application is an application program having a file transfer function to exchange a data file with another apparatus connected to the information communication terminal 1 through a network or directly. Also as explained earlier, the music streaming application is an application program having a function to transmit multimedia data such as video and audio data to another apparatus through a network and reproduce multimedia data while receiving the data from another apparatus through the network in a streaming reproduction process. Also as described earlier, the communication application is an application program making use of the communication engine and the VoIP engine in order to allow the user to communicate with (a user utilizing) another apparatus through the so-called IP telephone function or a voice chatting function through a network. Also as explained before, the instant-messenger application is an application program having a function to allow chatting or a transfer of a file through a network. Also as explained earlier, the web browser is an application program used for viewing a web page through a network.

There are also application programs each having a plurality of functions. There are also application programs each having a plurality of functions making use of and not making use of processing of communications with another apparatus through a network. The functions not making use of processing of communications with another apparatus include a function to record audio data (such as mainly musical data), a still picture and a moving picture and a function to organize stored data into a database. On the other hand, the functions making use of processing of communications with another apparatus through a network include a function to exchange data with another apparatus and a function to reproduce data while receiving the data from another apparatus in a streaming reproduction process.

FIG. 15 is a diagram showing a typical display of a home screen 451, which immediately appears on the display unit 21 employed in the information communication terminal 1 typically when the power supply is turned on or when the home button 23 is pressed. The home screen 451 shows a menu as a list of application programs that can be executed in the information communication terminal 1. As an alternative, the displayed menu can also be a list of items each including a plurality of such application programs. In the case of the home screen 451 shown in FIG. 15, the displayed menu shows a standby screen 461, a communication application 462, a music tool 463, a web browser 464, a photo viewer 465, a text editor 466, a voice memo tool 467 and a variety of tools 468 in a state of being selectable. If application programs executable in the information communication terminal 1 cannot all be displayed on one page of the home screen 451, the user may operate an up or down key of the 4-direction keys 26 in order to scroll the displayed list of the menu in the upward or downward direction respectively. In this way, the user is capable of viewing all the application programs included on the list. The user is allowed to select an application program from the displayed menu of the home screen 451 appearing on the display unit 21 and activate the selected program.

It is to be noted that, in accordance with a typical method adopted by the user to select and determine an application program from the menu, for example, the user operates the down or up key of the 4-direction keys 26 to change the selected item in the menu. The selected item in the menu is an item pointed to by a cursor. The menu is scrolled in the upward direction when the user presses the up key of the 4-direction keys 26 with the menu top item pointed by the cursor and scrolled in the downward direction when the user presses the down key of the 4-direction keys 26 with the menu bottom item pointed by the cursor. Then, after placing the cursor at a position to point to a desired item in the menu by operating the down or up key, the user presses the enter button 27 in order to confirm the selection of the desired menu item pointed to by the cursor as a selected application program. When the user confirms the selection of the desired menu item pointed to by the cursor as the selected application program by pressing the enter button 27, the program is activated. In accordance with another typical method adopted by the user to select an application program and confirm the selection of the application program from the menu, for example, with the third item in the menu assumed to be an always selected menu item, the user operates the down or up key of the 4-direction keys 26 in order to scroll the entire menu in the downward or upward direction respectively. In this way, different programs occupy the position of the third item serving as the always selected menu item. The user continues scrolling the menu till the desired application program occupies the position of the third item serving as the always selected menu item. As the desired application program occupies the position of the third item serving as the always selected menu item, the user presses the enter button 27 in order to confirm the selection of the third menu item as a selected application program. When the user confirms the selection of the third menu item as the selected application program by pressing the enter button 27, the program is activated.

Next, the communication-state notification light emitting device 34 is explained in detail as follows.

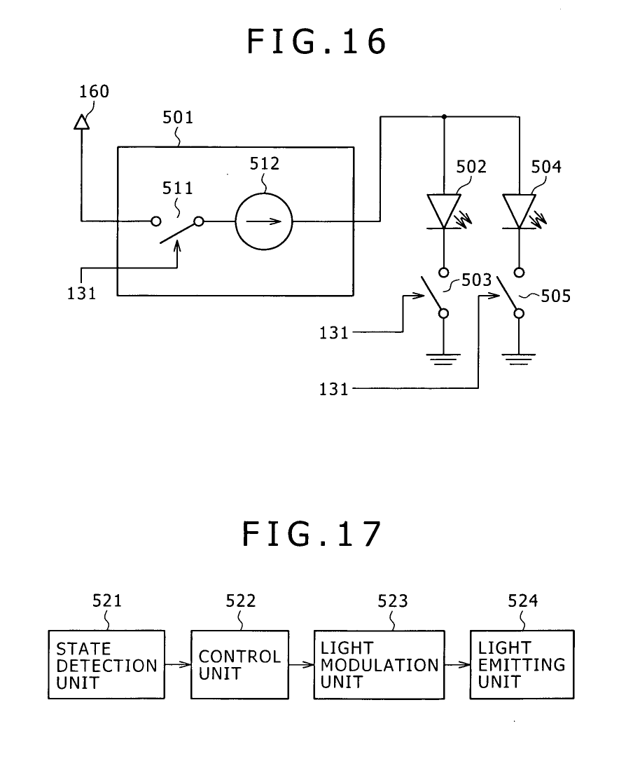

FIG. 16 is a diagram showing a model serving as a equivalent circuit including the light emitting device 84 employed in the communication-state notification light emitting unit 34. As shown in the figure, the light emitting device 84 employed in the communication-state notification light emitting unit 34 has an light emitting device driver 501, a blue LED 502, an orange LED 504 as well as switches 503 and 505.

One of terminals of a switch 511 employed in the light emitting device driver 501 is connected to the battery 160 and the other terminal is connected to a constant current supply 512. When the switch 511 employed in the light emitting device driver 501 is switched into an on state by on/off PWM (Pulse Width Modulation) control executed by the application processor 131, DC power generated by the battery 160 is supplied to the constant current supply 512. The constant current supply 512 controls the DC power supplied by the battery 160 by way of the switch 511 in order to produce an output voltage of a constant level. The constant-level voltage output by the constant current supply 512 is supplied to the blue LED 502 and the orange LED 504.

The blue LED 502 is connected to the ground through a switch 503. By the same token, the orange LED 504 is connected to the ground through a switch 505. The switch 503 as well as the switch 505 are switched into on and off states by the on/off control executed by the application processor 131. When the switch 503 is turned on, the constant current supply 512 drives the blue LED 502 to emit light of a blue color while changing the luminance of the emitted light. By the same token, when the switch 505 is turned on, the constant current supply 512 drives the orange LED 504 to emit light of an orange color while changing the luminance of the emitted light.

That is to say, when the blue LED 502 or the orange LED 504 is emitting light, the application processor 131 executes not only control to the keep the blue LED 502 or the orange LED 504 in a state of continuously emitting the light or in a blinking state, but also control to gradually change the luminance of the emitted light in accordance with the operating state and/or operating mode of the information communication terminal 1. Thus, due to light reflection of the light guide tube 85, the communication-state notification light emitting device 34 emits light beams in blue, green and orange colors while changing the luminance of each of the light beams.

FIG. 17 is a block diagram showing a typical functional configuration of the communication-state notification light emitting unit 34. At least one of functional units shown in FIG. 17 is implemented by execution of a predetermined program in the application processor 131 employed in the information communication terminal 1 shown in FIG. 12.

As shown in FIG. 17, the communication-state notification light emitting device 34 includes the state detection unit 521, the control unit 522, the light modulation unit 523 and the light emitting unit 524.

The state detection unit 521 is a section for detecting the operating state of the information communication terminal 1. Typical operating states of the information communication terminal 1 are a state of transmitting data, a state of receiving data, a state of receiving an IP phone call using an VoIP engine, a state of making an IP phone call using the VoIP engine or a state of having voice chats. Of course, the operating state of the information communication terminal 1 is by no means limited to these examples.

The control unit 522 is a section for controlling the light modulation unit 523 on the basis of the operating state detected by the state detection unit 521 as the state of the information communication terminal 1.

The light modulation unit 523 is a section for adjusting a light beam to be emitted by the light emitting unit 524 in a predetermined color and at a predetermined luminance, gradually increasing the luminance of the light in order to gradually raise the level of brightness or decreasing the luminance of the light in order to gradually raise the level of darkness accordance with the control executed by the control unit 522. Details of the function of the light modulation unit 523 will be described later by referring to FIGS. 18 to 25.

Implemented by the blue LED 502 and the orange LED 504, the light emitting unit 524 is a section driven by the light modulation unit 523 to emit light beams.

FIGS. 18 to 25 are each a diagram showing typical light modulation carried out in accordance with the operating state of the information communication terminal 1 as modulation of light emitted by the light emitting unit 524. In each of FIGS. 18 to 25, the vertical axis represents the luminance of the emitted light whereas the horizontal axis represents the lapse of time.

FIG. 18 is a diagram showing typical light modulation of light emitted by the light emitting unit 524 when a state of transmitting data is detected as the operating state of the information communication terminal 1.

When the state detection unit 521 detects a state of transmitting data as the operating state of the information communication terminal 1, in accordance with the detected operating state, the control unit 522 controls the light modulation unit 523 to gradually increase the luminance of the emitted light in order to gradually raise the level of brightness periodically at a period T1.

That is to say, under control executed by the control unit 522, the light modulation unit 523 gradually increases the luminance of light emitted by the light emitting unit 524 in order to gradually raise the level of brightness periodically at the period T1.

FIG. 19 is a diagram showing typical light modulation of the light emitted by the light emitting unit 524 when a state of receiving data is detected as the operating state of the information communication terminal 1.

When the state detection unit 521 detects a state of receiving data as the operating state of the information communication terminal 1, in accordance with the detected operating state, the control unit 522 controls the light modulation unit 523 to gradually decrease the luminance of the emitted light in order to gradually raise the level of darkness periodically at a period T2.

That is to say, under control executed by the control unit 522, the light modulation unit 523 gradually decreases the luminance of light emitted by the light emitting unit 524 in order to gradually raise the level of darkness periodically at the period T2.

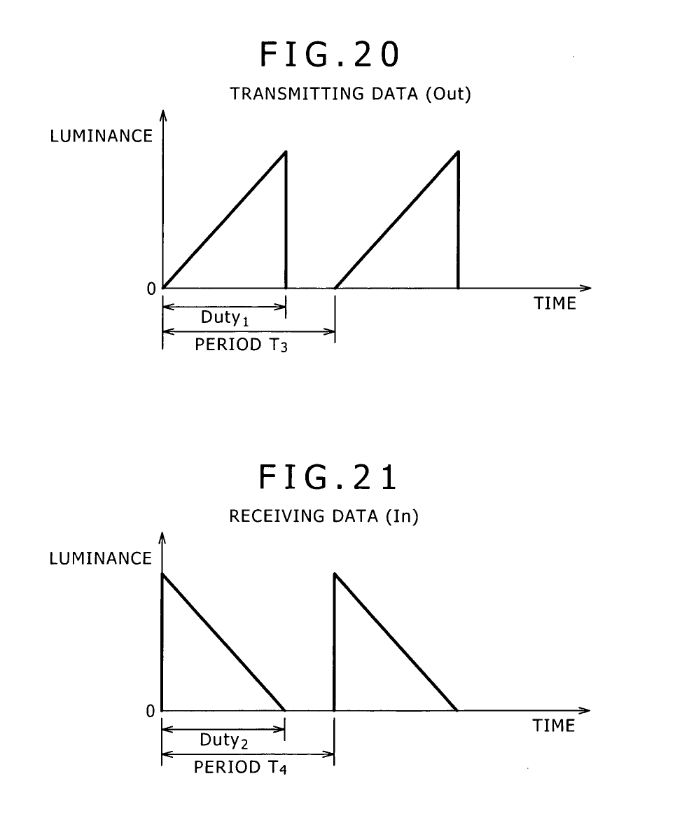

FIG. 20 is a diagram showing other typical light modulation of the light emitted by the light emitting unit 524 when a state of transmitting data is detected as the operating state of the information communication terminal 1.

When the state detection unit 521 detects a state of transmitting data as the operating state of the information communication terminal 1, in accordance with the detected operating state, the control unit 522 controls the light modulation unit 523 to gradually increase the luminance of the emitted light at a duty cycle Duty1 in order to gradually raise the level of brightness periodically at a period T3.

That is to say, under control executed by the control unit 522, the light modulation unit 523 gradually increases the luminance of light emitted by the light emitting unit 524 at a duty cycle Duty1 in order to gradually raise the level of brightness periodically at the period T3.

FIG. 21 is a diagram showing other typical light modulation of the light emitted by the light emitting unit 524 when a state of receiving data is detected as the operating state of the information communication terminal 1.

When the state detection unit 521 detects a state of receiving data as the operating state of the information communication terminal 1, in accordance with the detected operating state, the control unit 522 controls the light modulation unit 523 to gradually decrease the luminance of the emitted light at a duty cycle Duty2 in order to gradually raise the level of darkness periodically at a period T4.

That is to say, under control executed by the control unit 522, the light modulation unit 523 gradually decreases the luminance of light emitted by the light emitting unit 524 at a duty cycle Duty2 in order to gradually raise the level of darkness periodically at the period T4.

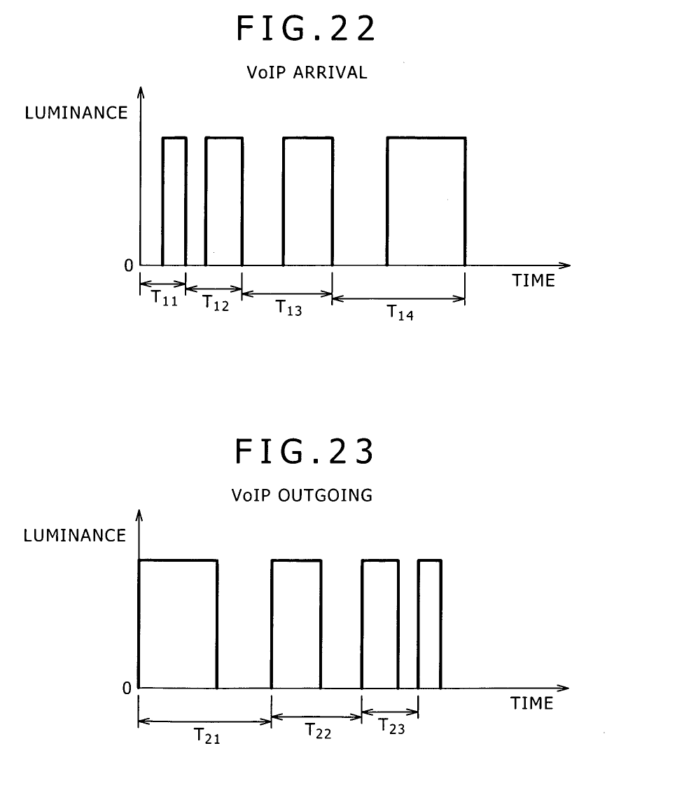

FIG. 22 is a diagram showing further typical light modulation of the light emitted by the light emitting unit 524 when a VoIP arrival is detected as the operating state of the information communication terminal 1.

When the state detection unit 521 detects a VoIP arrival as the operating state of the information communication terminal 1, in accordance with the detected operating state, the control unit 522 controls the light modulation unit 523 to gradually increase the blinking period of the emitted light from T11 to T12, then to T13, then to T14 and so on.

That is to say, under control executed by the control unit 522, the light modulation unit 523 drives the light emitting unit 524 to gradually increase the blinking period of the emitted light from T11 to T12, then to T13, then to T14 and so on.

FIG. 23 is a diagram showing still further typical light modulation of the light emitted by the light emitting unit 524 when a VoIP outgoing is detected as the operating state of the information communication terminal 1.

When the state detection unit 521 detects a VoIP outgoing as the operating state of the information communication terminal 1, in accordance with the detected operating state, the control unit 522 controls the light modulation unit 523 to gradually decrease the blinking period of the emitted light from T21 to T22, then to T23, then to T24 and so on.

That is to say, under control executed by the control unit 522, the light modulation unit 523 drives the light emitting unit 524 to gradually decrease the blinking period of the emitted light from T21 to T22, then to T23, then to T24 and so on.

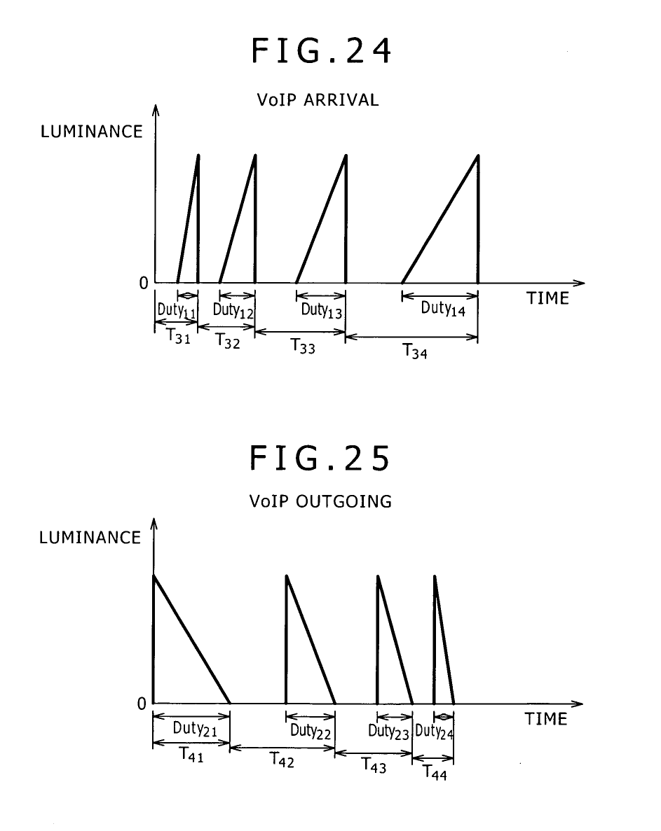

FIG. 24 is a diagram showing still further typical light modulation of the light emitted by the light emitting unit 524 when a VoIP arrival is detected as the operating state of the information communication terminal 1.

When the state detection unit 521 detects a VoIP arrival as the operating state of the information communication terminal 1, in accordance with the detected operating state, the control unit 522 controls the light modulation unit 523 to gradually increase the luminance of the emitted light at a duty cycle increasing from Duty11 to Duty12, then to Duty13, then to Duty14 and so on in order to gradually raise the level of brightness, gradually increasing the blinking period of the emitted light from T31 to T32, then to T33, then to T34 and so on.

That is to say, under control executed by the control unit 522, the light modulation unit 523 drives the light emitting unit 524 to gradually increase the luminance of the emitted light at a duty cycle increasing from Duty11 to Duty12, then to Duty13, then to Duty14 and so on in order to gradually raise the level of brightness, gradually increasing the blinking period of the emitted light from T31 to T32, then to T33, then to T34 and so on.

FIG. 25 is a diagram showing still further typical light modulation of the light emitted by the light emitting unit 524 when a VoIP arrival is detected as the operating state of the information communication terminal 1.

When the state detection unit 521 detects a VoIP arrival as the operating state of the information communication terminal 1, in accordance with the detected operating state, the control unit 522 controls the light modulation unit 523 to gradually decrease the luminance of the emitted light at a duty cycle decreasing from Duty21 to Duty22, then to Duty23, then to Duty24 and so on in order to gradually raise the level of darkness, gradually decreasing the blinking period of the emitted light from T41 to T42, then to T43, then to T44 and so on.

That is to say, under control executed by the control unit 522, the light modulation unit 523 drives the light emitting unit 524 to gradually decrease the luminance of the emitted light at a duty cycle decreasing from Duty21 to Duty22, then to Duty23, then to Duty24 and so on in order to gradually raise the level of darkness, gradually decreasing the blinking period of the emitted light from T41 to T42, then to T43, then to T44 and so on.

As described above, the luminance of the light emitted by the light emitting unit 524 is gradually increased in order to gradually raise the level of brightness, the luminance of the light emitted by the light emitting unit 524 is gradually decreased in order to gradually raise the level of darkness, the blinking or on period of the light emitted by the light emitting unit 524 is gradually increased, the blinking or on period of the light emitted by the light emitting unit 524 is gradually decreased and/or the color of the light emitted by the light emitting unit 524 is changed in order to notify the user of the operating or communication state of the information communication terminal 1 by making use of optical expressions, which are easy to understand. That is to say, the user is capable of recognizing the present operating or communication state of the information communication terminal 1 without the need to look at a screen showing information on the state of the information communication terminal 1. In addition, by making use of such optical expressions, the user is made capable of identifying the present operating or communication state of the information communication terminal 1 with ease even if the user is present at a location remote from the information communication terminal 1.

FIGS. 18 to 25 are each no more than a diagram showing typical light modulation carried out in accordance with the operating or communication state of the information communication terminal 1 as modulation of light emitted by the light emitting unit 524. It is to be noted, however, that modulations of light emitted by the light emitting unit 524 are by no means limited to those shown in the figures. That is to say, any synchronization and/or any combination of optical expressions and/or colors of the emitted light can be used as long as the synchronization and/or the combination shows the current operating or communication state of the information communication terminal 1. In other words, the duty cycle Duty, the period T, the gradient of the luminance and/or the linearity of the luminance change can be varied. In addition, if the blinking period is gradually increased as is the case with the light modulations shown in FIGS. 22 and 24, control based on a half-wave method or the like can be adopted in place of the control based on the rectangular-wave method.

On top of that, light emission patterns like the ones described above can be stored by being associated with the operating states of the information communication terminal 1.

By referring to a flowchart shown in FIG. 26, the following description explains processing to receive data by carrying out a file-transfer function.

The flowchart shown in FIG. 26 begins with a step S1 at which the radio communication module 148 produces a result of determination as to whether or not a data file has been received from another apparatus directly connected to the information communication terminal 1 or by way of the network 11. If the result of the determination indicates that a data file has not been received from another apparatus, the flow of the processing goes back to the step S1 at which the process of determination is repeated. As a matter of fact, the process of determination of the step is carried out repeatedly till the result of the determination indicates that a data file has been received from another apparatus.

As the determination result produced at the step S1 indicates that a data file has been received from another apparatus, the flow of the processing goes on to a step S2 at which the state detection unit 521 detects a state of receiving a data file as the state of the information communication terminal 1. At the step S2, on the basis of a detection result produced by the state detection unit 521, the control unit 522 carries out a process to turn on the light emitting device in order to indicate that a data file is being received. The process to turn on the light emitting unit 524 in order to indicate that a data file is being received will be described later in detail. In this process, the communication-state notification light emitting device 34 emits light according to a light emission pattern determined in advance at a predetermined period.

Then, at the next step S3, the radio communication module 148 is receiving the data file from the other apparatus directly connected to the information communication terminal 1 or by way of the network 11. Subsequently, at the next step S4, the radio communication module 148 produces a result of determination as to whether or not the process to receive the data file has been completed. If the result of the determination indicates that the process to receive the data file has not been completed, the flow of the processing goes back to the step S3 to repeat the processes of the steps S3 and S4. As a matter of fact, processes of the steps S3 and S4 are carried out repeatedly till the determination result produced at the step S4 indicates that the process to receive the data file has been completed.

As the determination result produced at the step S4 indicates that the process carried out by the information communication terminal 1 to receive the data file has been completed, the state detection unit 521 detects the completion of the process to receive the data file and, then, the flow of the processing goes on to a step S5.

At the step S5, on the basis of a detection result produced by the state detection unit 521, the control unit 522 carries out a process to turn off the light emitting device, which is used for indicating reception of a data file by execution of the file transfer function, in order to notify the user that the process to receive the data file has been completed. Finally, the processing to receive a data file by execution of the file transfer function is ended.

By referring to a flowchart shown in FIG. 27, the following description explains the process carried out at the step S2 of the flowchart shown in FIG. 26 to turn on the light emitting device in order to indicate that a data file is being received. As shown in FIG. 24, the emitted light is modulated in order to gradually raise the brightness by gradually increasing the luminance of the emitted light at a predetermined duty cycle.

The flowchart shown in FIG. 27 begins with a step S11 at which the control unit 522 sets the PWM duty value of the light emitting device for indicating reception of a data file by execution of the file transfer function. Then, at the next step S12, the control unit 522 sets a timer value. In the typical light modulation shown in FIG. 24, the control unit 522 sets the PWM duty value and the timer value at Duty11 and T31 respectively. Subsequently, at the next step S13, on the basis of the set timer value, the control unit 522 starts a timer operation to count the number of pulses. In addition, the control unit 522 makes use of the light modulation unit 523 to execute PWM control to gradually increase the luminance of light emitted by the light emitting unit 524 in order to gradually raise the level of brightness.

Then, at the next step S14, the control unit 522 produces a result of determination as to whether or not the process to receive the data file has been completed, that is, whether or not the number of counted pulses has reached the timer value set at the step S12. If the result of the determination indicates that the number of counted pulses has not reached the timer value, the flow of the processing goes back to the step S14 at which the process of determination is repeated. As a matter of fact, the process of determination of the step is carried out repeatedly till the result of the determination indicates that the number of counted pulses has reached the timer value.

As the determination result produced at the step S14 indicates that the number of counted pulses has reached the timer value, the flow of the processing goes on to a step S15 at which the control unit 522 produces a result of determination as to whether or not the process to turn on the light emitting unit 524 has been completed. If the result of the determination indicates that the process to turn on the light emitting unit 524 has not been completed, the flow of the processing goes on to a step S16.

At the step S16, the control unit 522 increases the PWM duty value of the light emitting device for indicating reception of a data file by execution of the file transfer function. Then, at the next step S17, the control unit 522 increases the timer value. In the typical light modulation shown in FIG. 24, the control unit 522 increases the PWM duty value and the timer value to Duty12 and T3 respectively. Subsequently, the flow of the processing goes back to the step S14 to repeat the processes described above.

If the determination result produced at the step S15 indicates that the process to turn on the light emitting device has been completed, on the other hand, the flow of the processing goes back to the step S3 of the flowchart shown in FIG. 26 to carry out the processes of the step S3 and the subsequent steps.

By carrying out the processing described above, light can be emitted in accordance with a light emission pattern in a process to receive a data file by execution of a file transfer function.

By referring to a flowchart shown in FIG. 28, the following description explains processing to transmit data by carrying out a file-transfer function.

The flowchart shown in FIG. 28 begins with a step S31 at which the radio communication module 148 produces a result of determination as to whether or not transmission of a data file to another apparatus directly connected to the information communication terminal 1 or transmission of a data file to another apparatus by way of the network 11 has been started. If the result of the determination indicates that transmission of a data file to another apparatus has not been started, the flow of the processing goes back to the step S31 at which the process of determination is repeated. As a matter of fact, the process of determination of the step is carried out repeatedly till the result of the determination indicates that transmission of a data file to another apparatus has been started.

As the determination result produced at the step S31 indicates that transmission of a data file to another apparatus has been started, the flow of the processing goes on to a step S32 at which the state detection unit 521 detects a state of transmitting a data file as the state of the information communication terminal 1. At the step S32, on the basis of a detection result produced by the state detection unit 521, the control unit 522 carries out a process to turn on a light emitting device in order to indicate that a data file is being transmitted. The process to turn on the light emitting unit 524 in order to indicate that a data file is being transmitted will be described later in detail. In this process, the communication-state notification light emitting device 34 emits light according to a light emission pattern determined in advance at a predetermined period.

Then, at the next step S33, the radio communication module 148 is transmitting the data file to the other apparatus directly connected to the information communication terminal 1 or transmitting the data file to the other apparatus by way of the network 11. Subsequently, at the next step S34, the radio communication module 148 produces a result of determination as to whether or not the process to transmit the data file has been completed. If the result of the determination indicates that the process to transmit the data file has not been completed, the flow of the processing goes back to the step S33 to repeat the processes of the steps S33 and S34. As a matter of fact, processes of the steps S33 and S34 are carried out repeatedly till the determination result produced at the step S34 indicates that the process to transmit the data file has been completed.

As the determination result produced at the step S34 indicates that the process to transmit the data file has been completed, the state detection unit 521 detects the completion of the process to transmit the data file and, then, the flow of the processing goes on to a step S35.

At the step S35, on the basis of a detection result produced by the state detection unit 521, the control unit 522 carries out a process to turn off the light emitting device, which is used for indicating transmission of a data file by execution of the file transfer function, in order to notify the user that the process to transmit the data file has been completed. Finally, the processing to transmit a data file by execution of the file transfer function is ended.

By referring to the flowchart shown in FIG. 27, the following description explains the process carried out at the step S32 of the flowchart shown in FIG. 28 to turn on a light emitting device in order to indicate that a data file is being transmitted. This time, however, it is assumed that the processing represented by the flowchart shown in FIG. 27 corresponds to the typical light modulation explained earlier by referring to FIG. 25. As described earlier, in the case of the typical light modulation explained earlier by referring to FIG. 25, the control unit 522 controls the light modulation unit 523 to gradually decrease the luminance of the emitted light at a duty cycle decreasing from Duty21 to Duty22, then to Duty23, then to Duty24 and so on in order to gradually raise the level of brightness, gradually decreasing the blinking period of the emitted light from T41 to T42, then to T43, then to T44 and so on.

The flowchart shown in FIG. 27 begins with a step S11 at which the control unit 522 sets the PWM duty value of a light emitting device for indicating transmission of a data file by execution of the file transfer function. Then, at the next step S12, the control unit 522 sets a timer value. In the typical light modulation shown in FIG. 25, the control unit 522 sets the PWM duty value and the timer value at Duty21 and T41 respectively. Subsequently, at the next step S13, on the basis of the set timer value, the control unit 522 starts a timer operation to count the number of pulses. In addition, the control unit 522 makes use of the light modulation unit 523 to execute control to gradually decrease the luminance of light emitted by the light emitting unit 524 in order to gradually raise the level of darkness.

Then, at the next step S14, the control unit 522 produces a result of determination as to whether or not the process to transmit the data file has been completed, that is, whether or not the number of counted pulses has reached the timer value set at the step S12. If the result of the determination indicates that the number of counted pulses has not reached the timer value, the flow of the processing goes back to the step S14 at which the process of determination is repeated. As a matter of fact, the process of determination of the step 14 is carried out repeatedly till the result of the determination indicates that the number of counted pulses has reached the timer value.

As the determination result produced at the step S14 indicates that the number of counted pulses has reached the timer value, the flow of the processing goes on to a step S15 at which the control unit 522 produces a result of determination as to whether or not the process to turn on the light emitting unit 524 has been completed. If the result of the determination indicates that the process to turn on the light emitting unit 524 has not been completed, the flow of the processing goes on to a step S16.

At the step S16, the control unit 522 decreases the PWM duty value of the light emitting device for indicating transmission of a data file by execution of the file transfer function. Then, at the next step S17, the control unit 522 decreases the timer value. In the typical light modulation shown in FIG. 25, the control unit 522 decreases the PWM duty value and the timer value to Duty22 and T42 respectively. Subsequently, the flow of the processing goes back to the step S14 to repeat the processes described above.

If the determination result produced at the step S15 indicates that the process to turn on the light emitting device has been completed, on the other hand, the flow of the processing goes back to the step S33 of the flowchart shown in FIG. 28 to carry out the processes of the step S33 and the subsequent steps.

By carrying out the processing described above, light can be emitted in accordance with a light emission pattern in a process to transmit a data file by execution of a file transfer function.

As described above, by applying the present invention, the information communication terminal 1 is capable of emitting light in accordance with a predetermined light emission pattern according to the communication state of the information communication terminal 1 and, hence, capable of notifying the user of the communication state in terms of an optical expression, which is easy to understand. That is to say, the user is capable of recognizing the present operating or communication state of the information communication terminal 1 without the need to look at a screen showing information on the state of the information communication terminal 1. In addition, by making use of such optical expressions, the user is capable of identifying the present operating or communication state of the information communication terminal 1 with ease even if the user is present at a location remote from the information communication terminal 1.

In addition, by letting the light guide tube 85 guide light emitted by the light emitting device 84 effectively, the light can be radiated to a large area. Thus, even by using only one light emitting device 84, large luminance changes can be implemented in a large area. As a result, increases and decreases in LED luminance can recognized with ease so that the operating state can be identified with ease in comparison with luminance changes of only a single LED.

The series of processes described previously can be carried out by hardware and/or execution of software. If the series of processes described above is carried out by execution of software, programs composing the software can be installed into a computer embedded in dedicated hardware, a general-purpose personal computer or the like from typically a recording medium. In this case, the computer or the personal computer serves as the information communication terminal 1 described above. A general-purpose personal computer is defined as a personal computer, which can be made capable of carrying out a variety of functions by installing a variety of programs into the personal computer.

The aforementioned recording medium for recording programs to be installed into a computer or a general-purpose personal computer as programs to be executed by the computer or the general-purpose personal computer respectively is typically a removable recording medium 172 provided to the user separately from the main unit of the computer as shown in FIG. 12. Examples of the removable recording medium 172 include a magnetic disk such as a flexible disk, an optical disk such as a CD-ROM (Compact Disk-Read Only Memory) or a DVD (Digital Versatile Disk), a magneto-optical disk such as an MD (Mini Disk, a trademark) as well as a semiconductor memory.

In this specification, steps of each program recorded on the recording medium can be carried out not only in a pre-prescribed order along the time axis, but also concurrently or individually.

It is worth noting that the technical term ‘system’ used in this specification implies the configuration of a confluence including a plurality of apparatus.

It is to be noted that embodiments of the present invention are by no means limited to the embodiments described above. In addition, it is possible to make a variety of changes in a range not deviating from essentials of the present invention.

What is claimed is:

1. An information communication terminal comprising:
a light emitting unit configured to emit light in accordance with an operation carried out by said information communication terminal;
a state detection unit configured to detect an operating state of said information communication terminal; and
a control unit configured to execute control of changing the state of emission of said light emitted by said light emitting unit on the basis of said operating state detected by said state detection unit.

2. The information communication terminal according to claim 1 wherein
said control unit changes the luminance of light emitted by said light emitting unit on the basis of said operating state of said information communication terminal.

3. The information communication terminal according to claim 2 wherein
said control unit controls the luminance of light emitted by said light emitting unit by increasing said luminance from a first light emission luminance value to a second light emission luminance value greater than said first light emission luminance value over a predetermined period of time.

4. The information communication terminal according to claim 3 wherein,
after the luminance of light emitted by said light emitting unit is increased to said second light emission luminance value in accordance with said control of said luminance over said predetermined period of time, said control unit drives said light emitting unit to transmit light at said first light emission luminance value over another predetermined period following said predetermined period of time.

5. The information communication terminal according to claim 4 wherein
said control unit controls the luminance of light emitted by said light emitting unit periodically by gradually increasing at least one of said predetermined period of time and said other predetermined period.

6. The information communication terminal according to claim 2 wherein
said control unit controls the luminance of light emitted by said light emitting unit by decreasing said luminance from a first light emission luminance value to a second light emission luminance value smaller than said first light emission luminance value over a predetermined period of time.

7. The information communication terminal according to claim 6 wherein,
after the luminance of light emitted by said light emitting unit is decreased to said second light emission luminance value in accordance with said control of said luminance over said predetermined period of time, said control unit drives said light emitting unit to transmit light at said first light emission luminance value over another predetermined period following said predetermined period of time.

8. The information communication terminal according to claim 7 wherein said control unit controls the luminance of light emitted by said light emitting unit periodically by gradually decreasing at least one of said predetermined period of time and said other predetermined period.

9. The information communication terminal according to claim 1 wherein
said control unit changes the light emission period of light emitted by said light emitting unit on the basis of said operating state of said information communication terminal.

10. The information communication terminal according to claim 9 wherein
said control unit controls the light emission period of light emitted by said light emitting unit by gradually decreasing said light emission period.

11. The information communication terminal according to claim 9 wherein said control unit controls the light emission period of light emitted by said light emitting unit by gradually increasing said light emission period.

12. The information communication terminal according to claim 1 wherein
said operating state of said information communication terminal is a state of transmitting data from said information communication terminal or receiving data transmitted to said information communication terminal.

13. The information communication terminal according to claim 1 wherein said light emitting unit emits light through a light guide tube.

14. An information processing method comprising the steps of:
detecting an operating state of an information communication terminal; and
executing control to change the state of emission of light emitted by a light emitting unit employed in said information communication terminal on the basis of said operating state detected at said operation-state detecting step.

15. A recording medium used for recording a computer-readable program to be executed by a computer to carry out processing comprising the steps of:
detecting an operating state of an information communication terminal; and
executing control to change the state of emission of light emitted by light emitting unit employed in said information communication terminal on the basis of said operating state detected at said operation-state detecting step.

16. An information communication terminal comprising:
light emitting means configured to emit light in accordance with an operation carried out by said information communication terminal;
state detection means configured to detect an operating state of said information communication terminal; and
control means configured to execute control of changing the state of emission of said light emitted by said light emitting means on the basis of said operating state detected by said state detection means.
